(19) United States
(12) Patent Application Publication
(10) Pub. No.: US 2011/0320347 A1
(43) Pub. Date: Dec. 29, 2011

(54) Mobile Networked Payment System

(75) Inventors: John TUMMINARO, Palo Alto, CA (US); Rodney ROBINSON, Los Altos Hills, CA (US); David SCHWARTZ, San Francisco, CA (US)

(73) Assignee: OBOPAY, INC., Redwood City, CA (US)

(21) Appl. No.: 13/167,622

(22) Filed: Jun. 23, 2011

Related U.S. Application Data
(63) Continuation of application No. 61/357,949, filed on Jun. 23, 2010.
Application No. 61/357,949 is a continuation of application No. 12/405,203, filed on Mar. 16, 2009.
Application No. 12/405,203 is a continuation of application No. 12/470,482, filed on May 21, 2009.
Application No. 12/470,482 is a continuation of application No. 11/694,891, filed on Mar. 30, 2007.
Application No. 11/694,891 is a continuation of application No. 11/694,896, filed on Mar. 30, 2007, now Pat. No. 7,873,573.
Application No. 11/694,896 is a continuation of application No. 11/694,895, filed on Mar. 30, 2007, now abandoned.
Application No. 11/694,895 is a continuation of application No. 11/694,894, filed on Mar. 30, 2007.
Application No. 11/694,894 is a continuation of application No. 11/694,887, filed on Mar. 30, 2007.
Application No. 11/694,887 is a continuation of application No. 11/694,903, filed on Mar. 30, 2007.
Application No. 11/694,903 is a continuation of application No. 11/694,906, filed on Mar. 30, 2007, now abandoned.
Application No. 11/694,906 is a continuation of application No. 11/694,881, filed on Mar. 30, 2007.
Application No. 11/694,881 is a continuation of application No. 11/694,747, filed on Mar. 30, 2007.

(51) Int. Cl. G06Q 40/00

(52) U.S. Cl. 705/39

(57) ABSTRACT

A mobile payment platform and service provides a fast, easy way to make payments by users of mobile devices. The platform also interfaces with nonmobile channels and devices such as e-mail, instant messenger, and Web. In an implementation, funds are accessed from an account holder's mobile device such as a mobile phone or a personal digital assistant to make or receive payments. Financial transactions can be conducted on a person-to-person (P2P) or person-to-merchant (P2M) basis where each party is identified by a unique indicator such as a telephone number or bar code. Transactions can be requested through any number of means including SMS messaging, Web, e-mail, instant messenger, a mobile client application, an instant messaging plug-in application or “widget.” The mobile client application, resident on the mobile device, simplifies access and performing financial transactions in a fast, secure manner.

### CROSS-REFERENCE TO RELATED APPLICATIONS

This patent application claims the benefit of U.S. patent application Ser. No. 11/694,747, filed Mar. 30, 2007; Ser. No. 11/694,881, filed Mar. 30, 2007; Ser. No. 11/694,906, filed Mar. 30, 2007; Ser. No. 11/694,903, filed Mar. 30, 2007; Ser. No. 11/694,887, filed Mar. 30, 2007; Ser. No. 11/694,894, filed Mar. 30, 2007; Ser. No. 11/694,895, filed Mar. 30, 2007; Ser. No. 11/694,896, filed Mar. 30, 2007; Ser. No. 11/694,891, filed Mar. 30, 2007; and Ser. No. 12/470,482, filed Apr. 21, 2009; and, through them, U.S. patent applications 60/744,013, filed Mar. 30, 2006; 60/744,930, filed Apr. 15, 2006; and 60/870,484, filed Dec. 18, 2006, In addition, this application claims the benefit of U.S. patent application Ser. No. 12/405,203, filed Mar. 16, 2009, as well as provisional applications Ser. No. 60/036,866, filed Mar. 14, 2008; 61/060,188, filed Jun. 9, 2008; Ser. No. 61/095,290, filed Sep. 8, 2008; Ser. No. 61/095,292, filed Sep. 8, 2008; and Ser. No. 61/357,949, filed Jun. 23, 2010. All of the foregoing applications are incorporated herein by reference along with all other references cited in this application.

### FIELD OF THE INVENTION

Embodiments of the present invention relate generally to systems and techniques for effectuating financial transactions via mobile or networked devices, such as mobile or cellular phones or other networked devices, and more particularly to a mobile or networked payment transfer infrastructure and method for transferring payment. Further, embodiments of the present invention relate to a financial transaction system and more particularly to both closed-loop and open-loop financial transaction system for person-to-person and consumer-to-merchant transactions and methods for using the financial transaction system. Other embodiments relate to electronic payment systems for transferring good funds in real time or near real time, including transfers across international boundaries. Other embodiments relate to ledger and bank treasury management processes for managing funds transfers across accounts maintained at different institutions. Other embodiments relate to techniques for maintaining an electronic system of record across multiple accounts maintained at multiple institutions. Still other embodiments relate to systems and techniques for managing multi-channel, multi-network financial transactions that extend the availability of banking, payment and remittance services to new classes of users.

### BACKGROUND OF THE INVENTION

Historically, an account holder who wished to conduct a financial transaction, for example, to buy an item, has relied on various financial instruments such as currency, checks, credit cards, or debit cards. Unfortunately, all of these financial instruments have security issues, for example theft or fraud. When cash is lost or stolen, there is usually no recourse but to accept the loss. With other financial instruments, loss is not a major issue but fraud causes significant losses for the payment industry. Indeed, credit card, debit card and check fraud have been and continues as a major problem for the industry.

One reason that check fraud is so common arises from the need to physically present a check to the payer's bank. Thus, when a check is accepted in a financial transaction, the check is not guaranteed, or “good”, funds. Rather, the check is merely a piece of paper where the validity of the bank that it is drawn on must be verified together with the account that is used and the signature used to authorize the payment.

With a credit or debit card, fraud can occur, for example, when the merchant fails to properly verify the identity of the card user, who might be someone other than the cardholder. The user can be unauthorized but can rack up considerable charges before the issuer can deactivate the account. Similarly, online purchases can be conducted fraudulently, for example in the case of identity theft, where the card user is not authorized to use the card, but knows sufficient information about the cardholder to still conduct a transaction.

To limit these risks, it is desirable to have a payment system where the receiver of funds in a financial transaction is able to easily verify the validity of the entity holding the funds, the account number, the balance, and the identity of the person making the transaction. Further, what is needed is a more secure manner to access credit and debit cards to conduct financial transactions. A more secure process would reduce the costs associated with fraud and fraud management.

It is clear that merchants and consumers desire a simple, secure, ubiquitous method for concluding financial transactions. The increasing use of payment cards provide ample evidence that consumers prefer to use electronic payment systems that do not involve carrying large amounts of cash or require the writing of a check. However, even as the use of payments cards increases, some merchants have restricted or discouraged their use to because of the transaction costs as well as the high infrastructure expenses (such as the Payment Card Industry Data Security Standard) associated with traditional aging payment networks. Thus, even with the wide spread adoption of electronic payment systems, it is clear that there is an increasing need for faster, cheaper and more convenient electronic payment systems for completing financial transactions. Further, there is a need for an electronic payment system that is more individualized such that financial transactions are easily concluded in a manner similar to cash transactions.

Further, there is still a huge global population of people who rely primarily on cash transactions and who still need a convenient and cost effective electronic payment system to send and receive money. This need has led to the growing use of prepaid or stored value cards. Unfortunately, such cards are primarily designed to be used at a merchant who has invested in a point of sale transaction terminal and do not allow for person to person transfers or any transaction not involving specialized equipment. What is needed is an electronic payment system that enables financial transactions to be concluded between individuals and without the need to directly access any devices from third parties.

Although the majority of people do not have access to POS terminals, most have access to a portable wireless communications device, often referred to as cellular (or cell) or mobile devices, or other network-based device such as a personal computer. For purposes of simplicity and clarity, the discussion of mobile devices hereinafter will be deemed to include non-mobile devices that access the internet, where appropriate to the context.

There has been explosive growth in mobile telephony devices and other portable devices that handle communications. People will often remember to carry their mobile or cellular phones with them, even if they forget to carry their wallet or car keys and mobile phones are ubiquitous in the U.S. and in many countries around the world. Therefore, there is a great need for a system to permit mobile phones to provide access to payment services, including various forms of electronic payments, as well as other associated financial and mobile banking transactions.

Attempts to create a mobile payment system using cellular devices have been met with mixed success primarily because of the lack of a solution interoperable between mobile networks, and between payment networks. For instance, in some instance the cell phone must have an additional circuit device (or “chip”)—with a proprietary application—that is used to store account balances and/or account information. When the person holding the phone wishes to transfer funds, she must first find a party with the same technology (chip and application) to effect a transaction. While such systems may provide better protection against loss of funds than carrying cash, their proprietary nature inherently limits the deployment and adoption of such a solution.

Mobile devices are sometimes used for storing credit or debit card account information. However, transactions utilizing such a scheme require interfaces with the proprietary payment networks for settlement, such as those maintained by Visa or MasterCard. Not only do merchants pay these network operators and their agents steep recurring access and transaction fees, but they must install special equipment and applications to receive such payments from mobile devices, and therefore are often not able to accept payment from consumers who want to use such solutions. The need to upgrade or modify the traditional payment card infrastructure has been a significant impediment to payment innovations for many years, and has generally prevented people from using their mobile device in lieu of a wallet and plastic payment cards. Not only do payment cards carry a “high cost” acceptance, they are also subject to fraud and abuse, as they expose the account number of the payer, which if compromised can be used to fraudulently withdraw funds, rather than using the account number of the payee used to deposit monies. Attempts to use personal information such as PIN codes or cardholder ZIP codes have only provided limited fraud protection as demonstrated by the growth of payment card fraud.

Another limiting aspect of traditional payment card transactions is that multiple “registered” parties are involved in a typical transaction. The so called five-party-system involves the Issuing bank, the cardholder, the acquiring bank, the card acceptor, and the payment network. Such systems require the consumer to obtain an account affiliated with the payment network (e.g. Visa, MasterCard, American Express, Star . . . ) and for the merchant to also be signed up through their financial institutions for receiving payments from a particular service network. The 5 party payment systems are not well designed for person-to-person transactions where one party is not a merchant or is a casual acceptor of payments (small merchants). For example, if two students wanted to share the expenses for a pair of movie tickets, one student might wish to electronically transfer funds to the other student, which cannot be completed in a traditional 5 party payment network since neither of the students would be registered as a card acceptor. Accordingly, the traditional payment services deployed and operated by the payment card issuers and payment service networks are wholly ill-suited to person-to-person financial transactions.

Therefore, what is needed is a cost-effective payment system that enables an account holder the flexibility to conduct their financial transactions at any time, anywhere, over either a wired or wireless device having access to a communications network. What is also needed is a “mobile ATM” that people can carry as a cash-equivalent source that is accessible from a mobile phone or other networked device to perform transactions otherwise only possible using cash. In addition, what is needed is a software application and managed service that operates as a mobile ATM on a mobile phone or other networked platform to manage electronic transactions including person-to-person, person-to-merchant, merchant-to-merchant and other forms of payments, where the participants to the transaction are not necessarily affiliated to the same payment service network (e.g., Visa, MasterCard, American Express, Star . . . ), and where standard technology is employed. This mobile ATM should be secure, easy to use, and easy to obtain and deploy so that the ability to make payments is available to any party with access to an electronic source of funds, whether such source be a payment card account, a Demand Deposit Account, Stored Value Account or other forms of electronic money. Moreover, what is needed is a financial transaction system that facilitates payments without the substantial payment charges and the administrative inflexibilities associated with traditional five party payment networks, while at the same time offering a high level of security for the holder, the merchant and others involved in these financial transactions. Accordingly, the following embodiments and exemplary descriptions of inventions are disclosed.

### SUMMARY OF THE INVENTION

An electronic payment platform and service provides a fast, easy way for users of mobile and other networked devices to conduct electronic financial transactions between and among clients and servers who are connect to either a wired or wireless network. Thus, the present invention enables payments or remittances to merchants, institutions, individuals, or anyone else, substantially anywhere and anytime through wired or wireless communication. In at least some embodiments, the funds are ‘good’ funds, meaning that those funds, once received, are immediately accessible by the recipient without limitation from any pending settlement processes. The platform interfaces with mobile and non-mobile services including but not limited to SMS, email, IVR, IM, web, etc., using programming platforms including but not limited to J2ME and Brew, and network/transport layer protocols including but not limited to WAP, USSD and IP.

In an embodiment, a user maintains one or a plurality of accounts within the system of the present invention, or what can be referred to as a ‘user accounts’ or, in at least some instances, payment accounts. The user accounts are linked to the user by means of any suitable indicia, such as a mobile phone number, bar code, or any other sufficiently unique identifier. When the user desires to conduct or participate in a transaction, the account or accounts are accessed from the account holder's device such as a mobile phone, a personal digital assistant, or other device having access to a suitable communications network, enabling the user to make or receive payments. In at least some embodiments, a client application is loaded on the user's device to enable easy and/or faster access to such accounts and to the services embodied in the platform of the present invention.

Financial transactions can be conducted among individuals, or person-to-person (P2P); between individuals and merchants (P2M); or among merchants. In each case, each participant is identified by unique indicia such as a telephone number or bar code, as noted above. In an embodiment, a first user (the ‘sender’) seeking to conduct a transaction, and in particular seeking to send funds to another, enters on his network-connected device an indicia representative of a second user as the recipient of the funds. Typically, although not necessarily, the recipient also maintains an account or a plurality of accounts on the system of the present invention. In other instances, the recipient maintains an account with a financial institution that is not within the platform of the present invention. Regardless whether the recipient maintains an account on the system, the sender indicates the amount of money to be transferred to the recipient, and also enters a PIN or other authentication or authorization code to initiate the transaction.

The client device links, either through a wireless or a wired connection, to the electronic payment platform of the present invention. Transactions can be requested through any protocol or communication services capable of accessing a communications network and ultimately interfacing with a server residing on an open network such as the Internet, such as, for example, with any combinations of SMS messaging, e-mail messages, instant messaging, or ad-hoc communication protocols and services, as may be implemented using a mobile client application, an instant messaging plug-in application, a PC desktop, “widget”, and so on.

The electronic payment platform maintains, either directly or indirectly, a general ledger and a system of record indicating, for each user and for each account of such user, their account balance as well as other relevant data. The payment platform confirms the availability of funds from the sender's account or accounts and, assuming sufficient funds are available, initiates a general ledger transfer and the removal of those funds from the sender's account or accounts and the forwarding of those funds to the recipient's account. Various methods for such debiting and forwarding can be implemented, depending upon the particular embodiment, and can comprise, as just some examples, placing a hold on the appropriate amount of funds in the sender's account, transferring the funds to a holding account, transferring the funds to a pooled account, or transferring the funds to an account linked to the recipient. At an appropriate time, the recipient is notified of the pending transfer, typically either before or promptly after the transfer has been made although the specific sequence can vary with the embodiment.

In some embodiments, where both sender and recipient maintain accounts within the system of the invention, transactions can occur essentially in real time or near-real time. In such embodiments, when a transaction is performed, a funds transfer operation occurs promptly after transaction submission and validation, which results in good funds becoming immediately unavailable to the sender and immediately available to the recipient. In other embodiments, transactions can be handled in non-real time. In some embodiments, where the sender and recipient each maintain an account within the system of the present invention, the transaction can operate as a closed loop; that is, there is no intervening third party processor or payment services network. This permits such transactions to be processed at very low, and in some instances no, cost.

In at least some embodiments, the system of the present invention interfaces with other financial institutions, such that the system accounts of a sender and a recipient are actually resident in these other financial institutions, yet still identified as accounts maintained within the system of the present invention. The account of the sender need not be maintained at the same institution as the account of the recipient, and the system of the present invention can still execute seamless real-time or near-real-time funds transfers since the system maintains a general ledger and includes related treasury management functions. The bank treasury management processes to enable such transfers are an aspect of some embodiments of the invention. Even with such cross-bank transfers, the operation can be conducted closed loop in some embodiments, such that no third party processor or payment services network is required. In other embodiments, third party processors can be used to provide additional services, and a transaction can be conducted open loop through these third party processors or networks. For example, the system of the present invention can be utilized to electronically release linked credit/debit information, shipping information, or other information during a mobile payment scenario, where such other information is managed by or provided to a third party.

In some embodiments, the accounts of the users are either prepaid accounts or demand deposit accounts maintained at partner financial institutions and linked to the system of the present invention. This permits the system of the present invention to keep costs low, since funds transfers within the system are managed through a combination of prepaid or linked funds, closed loop processing, and cross-bank settlement using cost efficient accounting processes. Because costs within the system can be kept very low, the present invention is well suited to one-off and bulk transfers of small monetary amounts. This is also assisted by the real-time and near real-time nature of funds transfers in some embodiments of the invention. It will be appreciated that the present invention provides a payment system that is lower cost and more efficient than traditional payment systems, as demonstrated in shorter delays before funds are available to the recipient, lower administrative requirements and higher security and protection of the sender's/payers account information. In addition, it will also be appreciated by those skilled in the art that the present invention can scale to very large numbers of users while keeping costs low and performance high. This offers the additional aspect of providing the ability to extend electronic payment services, and therefore banking services generally, to groups that do not currently have access to such facilities, without the administrative burden and inflexibilities of present payment networks. For example, remotely located consumers or small merchants, who have no reasonable physical access to a bank but have a cell phone or internet connection, have, by virtue of the present invention, the ability to conduct electronic payment services regardless of the volume and size of their transactions, and whether or not they own an account with a traditional financial institution.

An embodiment of the invention comprises a financial transactions system including a client adapted to connect to a network and having a consumer interface, a network interface to handle transaction requests from the client; bank treasury management functionality to manage transactions and to assure appropriate authentication, tracking and record-keeping for those transactions; and a messaging functionality to advise the sender and the recipient of their transaction and its status. In at least some embodiments these functionalities comprise a general ledger and a system of record. The system of the invention can include one or more pooled accounts, which can be distributed across multiple financial institutions, but linked by one or more systems of record so that cross-bank, and even cross-border, transactions can be managed seamlessly. Depending on the embodiment, the pooled accounts can be configured to retain all monies from all users in a single pooled account, with appropriate record-keeping to identify the funds held by each user, or the pooled accounts can be limited in use, such as for maintaining funds for newly registered users and thereby enabling such newly registered users to conduct transactions essentially immediately.

In some embodiments the system also includes a facility for managing the deposit and withdrawal of funds to accounts held in the system, which is also referred to as loading and unloading of accounts. Likewise, the system provides a facility for handling typical banking requests such as balance inquiries, transaction history, and so on, in addition to sending and requesting funds.

In at least some embodiments, the system includes a financial partner interface and a merchant interface, where users can interact with the system through a consumer interface to access, through the financial partner interface, their accounts or money at a bank connected to the system through any financial product offered by that financial institution, and also can interact with merchants connected to the merchant interface, such as sending money to or receiving money from such merchants. Thus, in an embodiment, the invention is a method comprising providing an application program interface to conduct transactions with a first financial partner; providing a messaging interface to receive requests to conduct transactions; and providing a client application interface to initiate requests to conduct transactions, whereby a user can request a funds transfer from a first account at a first financial or transaction partner to a second account at a second financial or transaction partner.

Some of the benefits of the invention include: encouraging the conversion of cash payments to electronic payments which are safer, more effective, and more traceable; providing electronic payments to any-one, at any-time and in any-place, in a real time or near-time operation; enabling a companion payment card (e.g., MasterCard, Visa, or other) for instant funds accessibility outside of the implementation of the system of the present invention, as well as also in circumstances where a traditional payment transaction is not possible such as for person-2-person (P2P) or person-2-merchant (P2M) transactions where the merchant is not equipped to read payment cards; facilitating electronic payments in a cross carrier or cross payment network manner; facilitating electronic payments in a cross device or cross channel manner (i.e., mobile, e-mail, Web, instant messenger).

Further, a closed-loop financial transaction system in accordance with an embodiment of the invention is based, in part, on the use of a cell phone, PDA or other device to make or receive payments. Financial transactions can be conducted on a person-to-person basis where each party is identified by a unique indicator such as a telephone number, e-mail address, instant messaging identifier, or bar code or on a consumer-to-merchant basis. In an embodiment, fee structures are disclosed to facilitate widespread adoption and system transparency thus freeing people from having to carry cash and insuring a balanced set of economic benefits for transaction participants.

In an embodiment, the invention is a financial transactions system including a consumer interface, connected to a network, including: a Web interface to handle transaction requests from a Web browser client; a mobile Internet browser interface to handle transaction requests from a mobile Internet browser on a mobile phone client; an SMS interface to handle transaction requests using SMS text messaging; and a mobile client application interface to handle requests from a mobile client application executing on a mobile phone client. The consumer interface can include an interactive voice response interface to handle requests from a telephone voice channel. The consumer interface can further include an instant messenger interface to handle requests from an instant messenger client.

The system can include a pooled account for newly registered users, where newly registered users can conduct transactions from registered users immediately after registration. The mobile client application interface can permit a send money transaction, loading account transaction, unload account transaction, and balance inquiry transaction.

The system can include: a financial partner interface; a merchant interface, where users through the consumer interface can access their money at a bank connected to the system through the financial partner interface and transfer money to merchants connected to the merchant interface. The system can include a system of record managed by the financial transaction system, recording transactions executed through the consumer interface. The system can include a pooled account managed by the financial transaction system, where a number of the clients accessing the system through the consumer interface have funds maintained on a T-ledger (sometimes referred to as a “T account”) in the pooled account. Either in addition to the pooled account or in the alternative, clients can also have an account at a financial institution which is linked to the system by any suitable means such as an appropriate network.

In an embodiment, the invention is a method including: providing an application program interface to conduct transactions with a first financial partner; providing an SMS messaging interface to receive requests to conduct transactions; and providing a mobile client application interface to receive requests to conduct transactions, where through the SMS messenger interface or the mobile client interface, a client can request a transfer money from a first account at the first financial partner to a second account at the second financial partner.

The method can further include providing an application program interface to conduct transactions with a second financial partner, where through the SMS messenger interface or the mobile client interface, a client can request a transfer of money from an account at the first financial partner to an account at the second financial partner. The method can include providing a system of record to record transactions requested through the SMS messaging and mobile client interfaces.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a block diagram of an embodiment of a system of the invention.

FIG. 2 illustrates in system topology form a more robust embodiment of the system of FIG. 1, including the software architecture of a payment system in accordance with the invention and its associated network connections.

FIG. 3 illustrates in network form an embodiment of the communications between the payment system of the present invention and the associated users and financial partners.

FIG. 4 illustrates in network diagram form an embodiment of the communications channels by which users are able to access the platform of the payment system of the present invention.

FIG. 5 illustrates, in simplified form, an embodiment of the ecosystem of the present invention, wherein the payment system of the present invention permits financial and other value transactions to be conducted among consumers, merchants, affiliates using services provided by banks and carriers.

FIG. 6 shows in greater detail the software architecture of the payment system of the embodiment shown in FIG. 1.

FIG. 7 illustrates the use of linked and in-place debit and credit cards as a means of the management of financial transactions in accordance with the invention.

FIG. 8 illustrates an embodiment of a method for registration of a new user.

FIG. 9 illustrates in flow diagram form the process by which a user upgrades from a pooled account to an individual account. In an embodiment, the individual account may have associated with it a debit card or, in some embodiments, a credit card.

FIG. 10 illustrates in flow diagram form the process by which a user adds money to an account within the payment system of the present invention using a credit or debit card and a card processor partner.

FIG. 11 illustrates in flow diagram form the process by which a user adds funds to an account within the payment system using a linked credit or debit account maintained within the partner bank.

FIG. 12 illustrates in flow diagram form the conduct of a financial transaction wherein a consumer A sends money to a consumer B, where both A and B have individual accounts.

FIG. 13 illustrates in flow diagram form the conduct of a financial transaction wherein consumer A sends money to consumer B, where neither A nor B maintains an individual account within the system.

FIG. 14 illustrates in flow diagram form the conduct of a financial transaction wherein consumer A sends money to consumer B, where consumer A maintains an individual account while consumer B's funds are maintained in a pooled account.

FIG. 15 illustrates in flow diagram form the conduct of a financial transaction wherein consumer A sends money to consumer B, where consumer A's funds are maintained in a pooled account while consumer B's funds are maintained in an individual account.

FIG. 16 illustrates in flow diagram form a cross-bank P2P transaction with bilateral settlement.

FIG. 17 illustrates in flow diagram form a cross-bank P2P transaction with centralized settlement.

FIG. 18 illustrates in flow diagram form a cross-bank settlement with centralized settlement, including roll-back capability.

FIG. 19 illustrates an unload process by which a holder of a system account transfer or “unloads” funds from the system account to a different, non-system account maintained by the holder.

FIG. 20 illustrates a viral transaction by which consumer A sends money to a consumer B, where consumer B is not registered with the system.

FIG. 21 illustrates an alternative version of a viral transaction wherein the sender's account is debited only after a pick-up event occurs.

FIG. 22 illustrates a viral registration process by which an unregistered recipient of funds becomes registered with the system and receives a viral payment.

FIG. 23 shows the use of velocity rules as a check against fraud.

FIG. 24 shows a system using a virtual pooled account.

FIG. 25 shows a tiered fraud detection system in accordance with an embodiment of the present invention.

FIGS. 26A and 26B show an embodiment of a fraud prevention technique involving the use of sequence numbers generated from a seed on a client device

FIGS. 27, 28 and 29 illustrate an embodiment of a multifactor authentication technique, including idempotence and antifraud aspects.

### DETAILED DESCRIPTION OF THE INVENTION

In this description of embodiments of the present invention, numerous specific details are provided, such as examples of components or methods, or both, to provide a thorough understanding of embodiments of the present invention. One skilled in the relevant art will recognize, however, that an embodiment of the invention can be practiced without one or more of the specific details, or with other apparatus, systems, assemblies, methods, components, parts, or the like, and combinations of these. In other instances, well-known structures, materials, or operations are not specifically shown or described in detail to avoid obscuring aspects of embodiments of the present invention.

In a specific implementation, the present invention relates to a mobile remittance and payment platform and service. An embodiment of the present invention encompasses a payment platform that provides a fast, easy way to make money transfers and payments by individuals or merchants using their mobile devices to access an account such as a stored value account with or without an associated card, a debit account, a demand deposit account or a credit account. Further interfaces include IM, Web services, and application widgets. Additional embodiments of the present invention encompass a variety of partners that include mobile phone operators, nationally branded merchants, payment services networks, and financial service providers together with a payment platform that provides a fast, easy way to make money transfers and payments by individuals using their mobile devices.

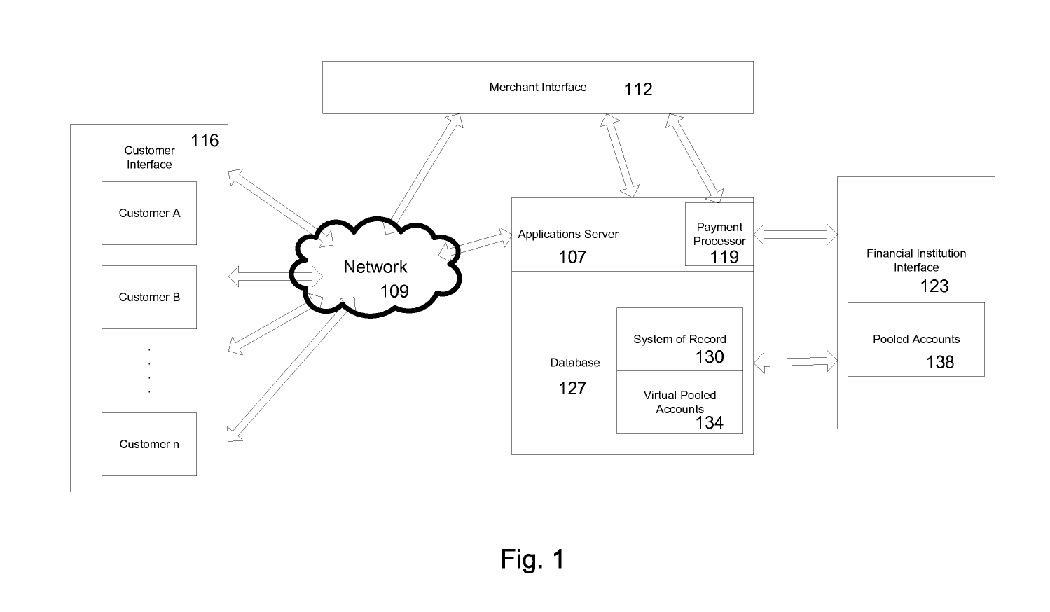

FIG. 1 shows a block diagram of a system of the invention for conducting value exchange transactions including in specific implementations, mobile person-to-person payments and transactions, mobile person-to-merchant payment transactions, and mobile banking. An applications server 107 is connected to a network 109. Although only one applications server is shown, there can be any number of applications servers in a system of the invention. Such applications servers can be executing on a single server machine or a number of server machines, which can be co-located or distributed geographically, including across various institutions.

A merchant interface 112 and a customer interface 116 are also connected to the network. This network can be any network that carries data including, but not limited to, the Internet, private networks, or virtual private networks, transported over such connections as enabled by public switch telephone network (PSTN), ISDN, DSL, wireless data networks, and many others, and combinations of these. The customer interface can handle any number of customers. The merchant interface is also connected to the applications server. Similar to the customer interface, there can be any number of merchants that connect to the application server.

On the applications server is a payment processor 119, which can also be connected to the merchant interface. The payment processor 119 can be any suitable payment processor, including ACH, payment card network, ATM network, and so on. A financial institution interface 123 is connected to the applications server and payment processor. There can be any number of financial institutions connected to the applications server. The applications server can also include a database 127. The database can include a system of record (SOR) 130 and virtual pooled accounts 134, which the applications server can manage. Alternatively, the SOR database can be on a separate server from the applications server and accessible to the applications server through a network or other connection. The financial institution is also connected to the database. The financial institution can manage pooled accounts 138. Therefore the system of record and virtual pooled accounts can be managed separately from the pooled accounts at the financial institution. It will be appreciated by those skilled in the art that the pooled accounts and other working accounts utilized within the system are typically commercial accounts.

In an embodiment, the system of record 130 comprises functionality for maintaining real time debit, credit, history and balance for the account of each user of the system, whether merchant, individual, financial institution, etc. The SOR database can comprise a ledger account, or “T” account, for each user to facilitate tracking that user's transactions. In some embodiments, the SOR 130 also maintains a record of each user's “know your customer” (KYC) and OFAC information, together with any other appropriate identifying information. In some embodiments the SOR 130 can also include anti-fraud and security data, including velocity related data. It will be appreciated by those skilled in the art that the partial or duplicate SOR's can be maintained at the servers of various entities within the network, to provide appropriate aspects of debit, credit, history and balance information as required for that particular entity's needs. In some embodiments, the system operator is an account aggregator and becomes the system of record in terms of risk and risk control. The system operator is also responsible for performing the OFAC compliance check. The system operator can be a bank, a financial institution, an association, or can subcontract the account management to another bank.

A system of the invention can include any number of the elements shown in the figure. The system can include other elements not shown. Some elements can be divided into separate blocks, or some elements can be incorporated or combined with other elements. Additionally, some elements can be substituted with other elements not shown.

In operation, the system of the invention facilitates financial transactions between consumers and between a consumers and a merchant. In an implementation, the consumer can initiate a transaction by using a mobile device, such as a mobile phone or smartphone, or personal device capable of a data network connection. Also, the recipient of a transaction can be a person having a mobile device, which is capable of accessing the mobile payment system.

In an implementation, the funding source of these financial transactions can be the owner or operator of the applications server (which can sometimes be referred to a mobile payment server or mobile payment service). Then, customers (and merchants) will be able to load or unload funds from the mobile payment service. These funds can be from any source including a check, cash, on-line payment solution, wire funds transfer, checking account, savings account, certificates of deposit, reverse mortgage account, brokerage account, dividends, bonds, hedge fund account, credit card, debit card, or any financial instrument, or any combination of these.

In other implementations, the funding source is a financial institution that is accessible by the user through the mobile payment server. Funds can be transferred between financial institutions if needed. For example, consumer A can send money to consumer B or a merchant, where parties have funds at different financial institutions. The mobile payment system will facilitate the transfer between the institutions and notify the parties appropriately.

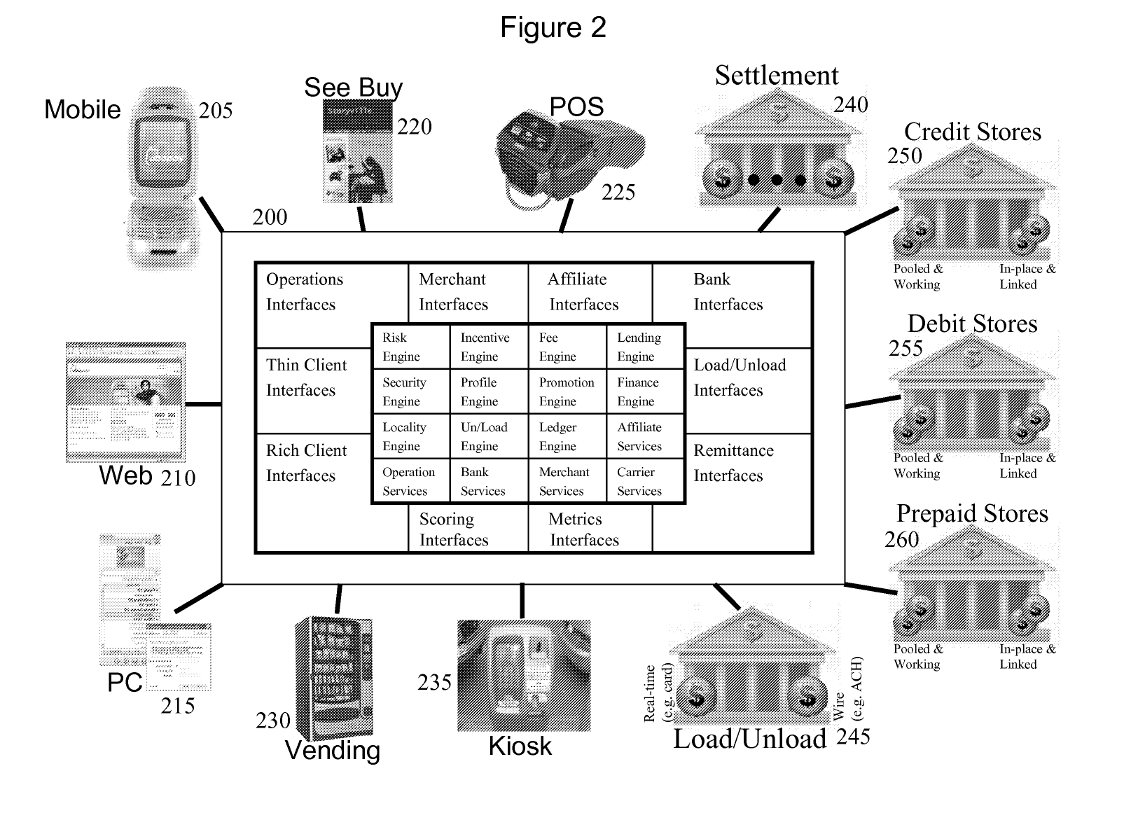

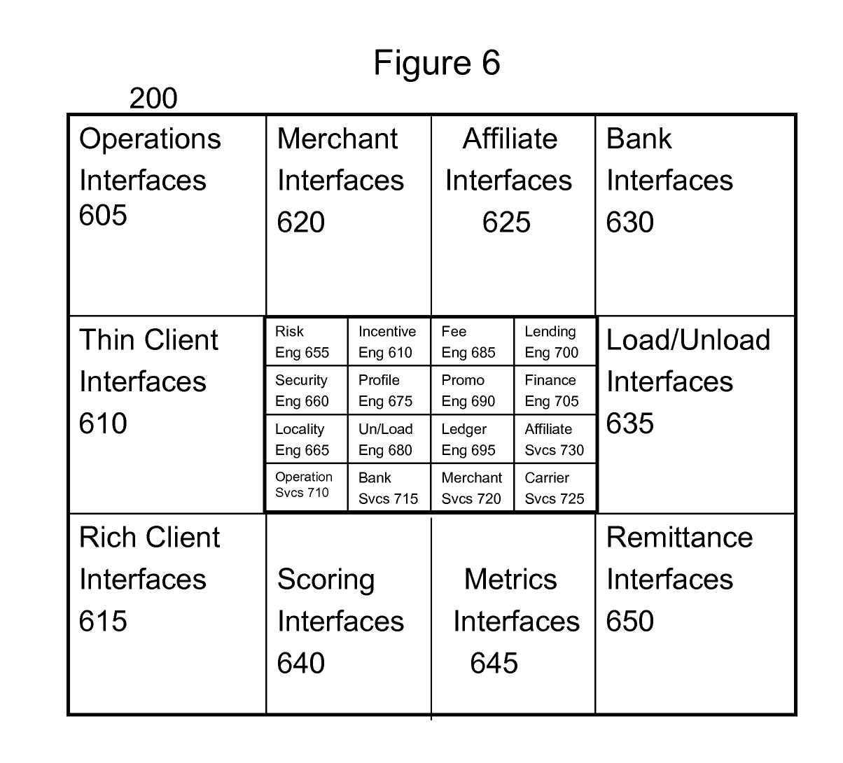

FIG. 2 shows a software architecture for a specific embodiment of the invention. This block diagram shows the layers and interconnections for a specific system architecture that can be implemented on the applications server, together with links to users and partners. A payment system 200 communicates with mobile devices 205, web-connected devices 210, and other devices such as PC's 215 by any convenient means. In addition, the system communicates with transaction-oriented devices such as “See-Buy” devices 220, POS terminals 225, vending machines 230 and kiosks 235. The system 200 also communicates with various financial institutions for purposes of settlement, shown at 240, load and unload, shown at 245, credit “stores” 250, or institutions offering credit-based relationships, debit stores 255, and prepaid stores 260. The payment system 200 comprises a plurality of functionalities, which are explained in greater detail in connection with FIG. 6. It will be appreciated that the various software functionalities shown are implemented and performed on one or more servers and related devices.

Those skilled in the art will further understand that various embodiments of the payment system will include, at the software architecture level, a web application container, a payment system container, a relational database, and a persistence layer. These can be provided by any of a number of sources well known to those skilled in the art. In the consumer web application container is a presentation layer for interface for different types of clients. Some examples of the interfaces provided include SMS gateway, phone application gateway, web services gateway, web application pages gateway, and web application framework gateway. The phone messaging codec converts the incoming or outgoing requests, or both, such as SMS or Phone into system or client specific messages. An architecture of the invention can include any number of these interfaces.

The payment system container includes connectors to external financial networks or security systems, mail servers, and messaging services. There is also a business logic interface and payment system business logic. Service clients can invoke the business services through business service gateway. Appropriate connectors or interfaces are provided so that instructions or other messages exchanged between the payment system and any other portion of the network, such as a financial institution or payment card network, are formatted for proper communication across those nodes. A system of the invention can include any number of the elements shown in the FIG. 2. The system can include other elements not shown. Some elements can be divided into separate blocks, or some elements can be incorporated or combined with other elements. Additionally, some elements can be substituted with other elements not shown.

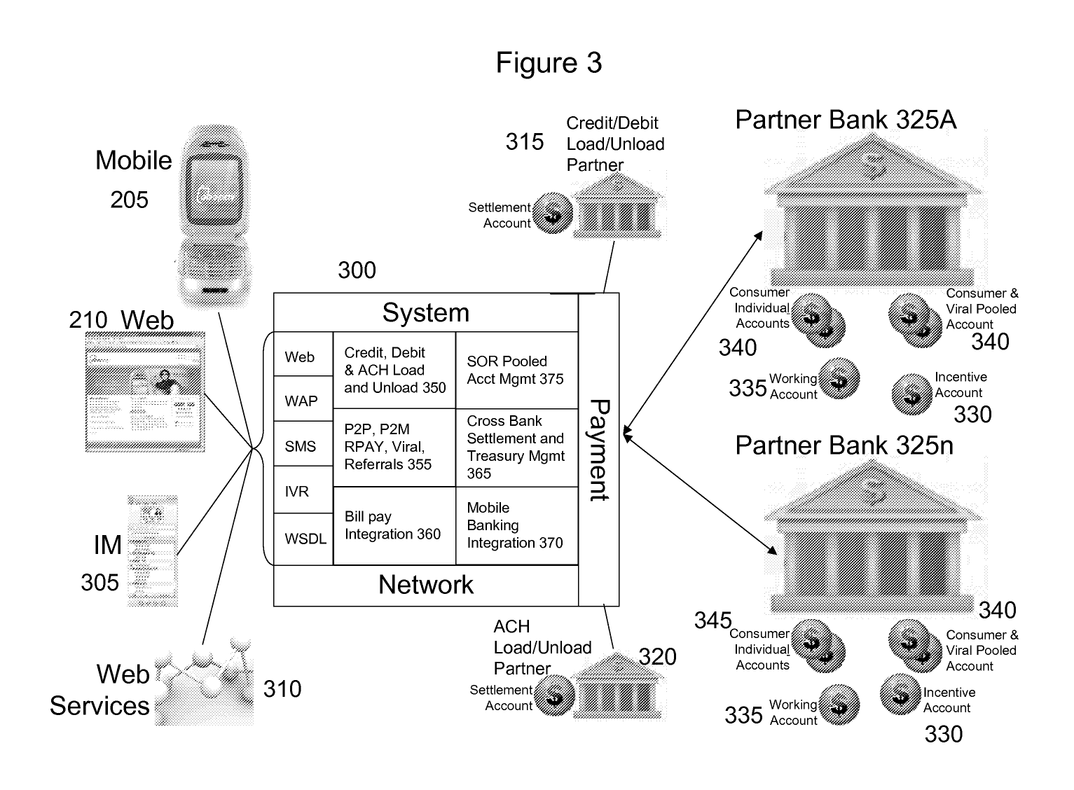

Referring next to FIG. 3, the relationship between the payment system 300, its users and its partners can be better appreciated from a financial perspective. As with FIG. 2, users can communicate with the system by any convenient means, using wired or wireless technologies including various mobile interfaces 205, web interfaces 210, IM 305, and web services 310, and communicates on the financial side with partner financial institutions for performing credit/debit, load/unload, shown at 315, or ACH load and unload, shown at 320. In addition, various partner banks or other financial institutions 325A-n offer services associated with the functions of the payment system, including a system working account 335, which can exist at each financial institution in at least some embodiments. Likewise, each financial institution 325A-n can have a system incentive or referral account 330 for providing financial or other incentives to new or existing users, as well as one or more pooled accounts 340, and a plurality of consumer individual accounts 345. It will be appreciated that, as used herein, “consumer” encompasses both individuals and merchants.

The payment system 300 provides a plurality of finance-related functions, including controlling the load and unload operations whether from a payment network interfacing with linked credit and debit accounts, such as payment card networks and systems, ATM networks, or ACH networks interfacing with linked Demand Deposit Accounts, shown at 350, managing P2P, P2M, RPAY (Remote Payment), Viral and Referral functions, shown at 355, bill payment integration, shown at 360, cross-bank settlement and integration, shown at 365, or mobile banking integration, shown at 370. In addition, the payment system 300 also provides a system of record, shown at 375, by which pooled account management and security and other related functions such as general ledger management are performed.

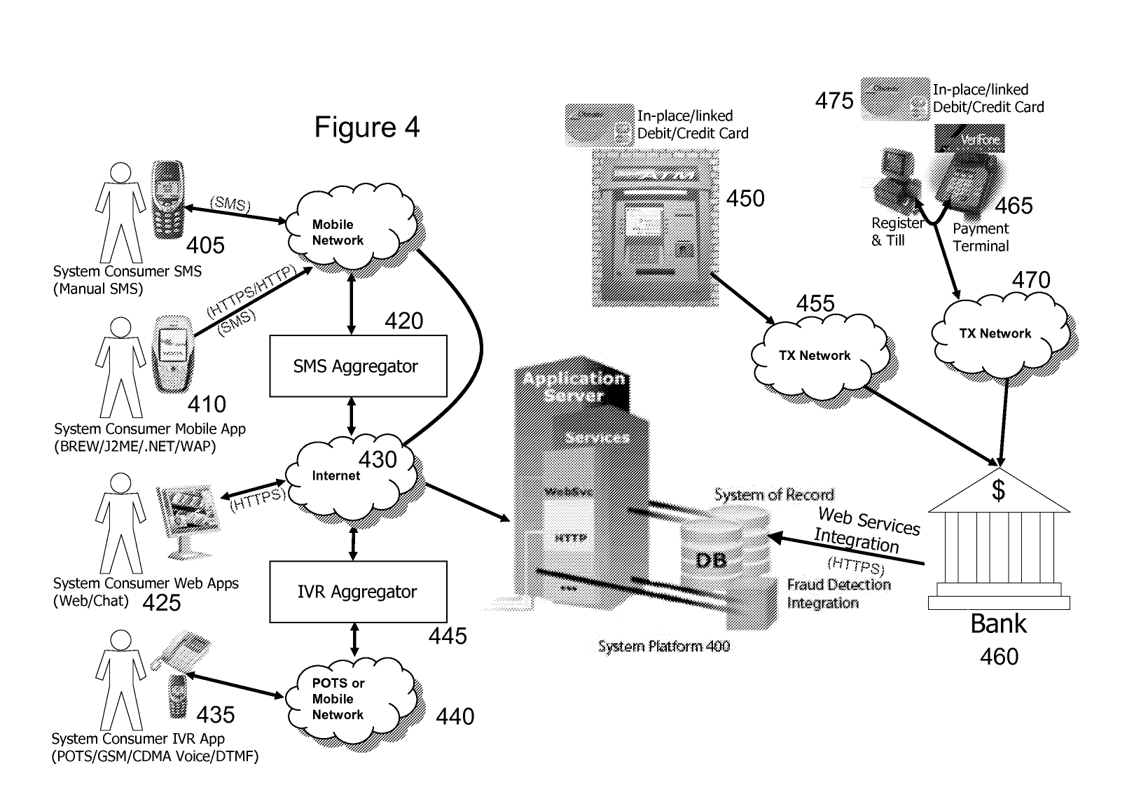

FIG. 4 illustrates a plurality of “touch points” by which consumers can access the payment services platform 400 of the present invention. Thus, the payment services platform 400, which in an embodiment typically comprises an application server aspect together with various communication interfaces and services layers, a database, and fraud detection engine, together with the aforementioned system of record, communicates via any suitable network by either wired or wireless means with consumer mobile devices, as shown at 405 and 410, communicating through mobile network 415 and SMS aggregator 420, or a consumer web application 425, communicating through the internet 430. Further, voice response functionality may be provided, as shown at 435, communicating with the payment system 400 through a conventional or mobile telephone network 440 and IVR aggregator 445, which can communicate through the internet 430 in at least some embodiments. In addition, the consumer can link to the payment system 400, in at least some embodiments, via ATM devices and their associated networks, shown at 450 and 455, that are linked to the payment system 400 through financial institutions 460. Similarly, users can access the payment system 400 through in-place or linked debit and credit cards 475 used at conventional cash registers or other payment terminals 465, linked to the financial institutions 460 through appropriate networks 470.

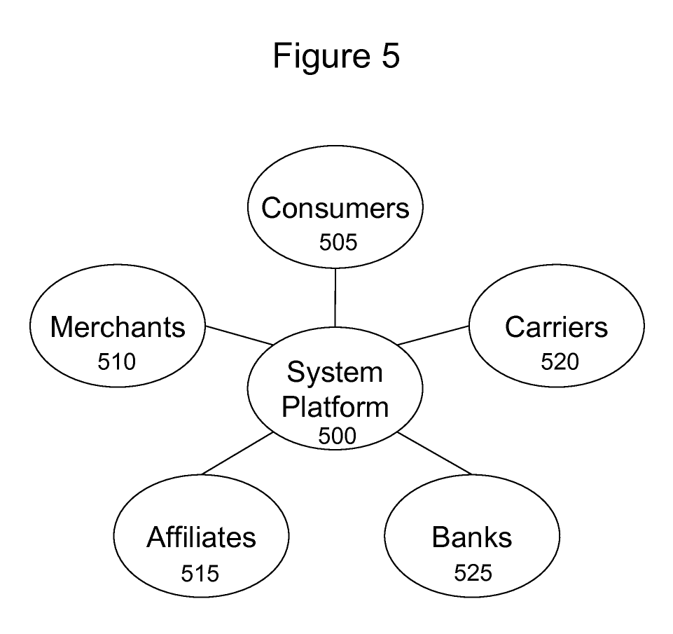

Thus, as shown in FIG. 5, it can be appreciated that the payment system 500 of the present invention provides the hub of a financial ecosystem linking users of various types, including individual consumers 505, merchants 510, affiliates 515, carriers 520 and banks or other financial institutions 525, permitting financial transactions to be performed, in many instances, in real time or near-real time, at significantly lower cost than with other payment services networks and with greater efficiency. In some embodiments, the payment system of the present invention operates closed loop, which assists is preserving ease of control and permits lower cost operation than with current open loop approaches.

Referring next to FIG. 6, the software architecture of the payment system 200 can be understood in greater detail. The payment system 200 communicates with the remaining system infrastructure through a series of interfaces, including operations interfaces 605, thin client interfaces 610, rich client interfaces 615, merchant interfaces 620, affiliate interfaces 625, bank interfaces 630, load/unload interfaces 635, scoring interfaces 640, metrics interfaces 645, and remittance interfaces 650.

The functionalities comprising the payment system 200 include a risk engine 655, a security engine 660, a locality engine 665, an incentive engine 670, a profile engine 675, a load/unload engine 680, a fee engine 685, a promotion engine 690, a ledger engine 695, a lending engine 700, and a finance engine 705. In addition, interfaces to various services are provided, including interfaces to operations services 710, bank services 715, merchant services 720, carrier services 725 and affiliate services 730.

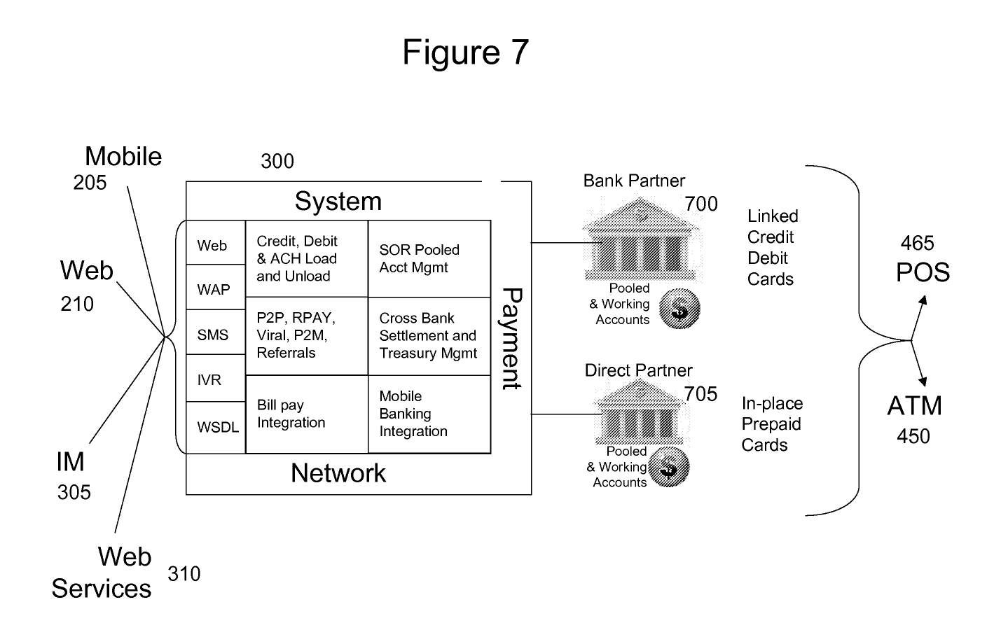

FIG. 7 illustrates a system topology for facilitating a variety of mobile person-to-person payments.

The mobile payment system allows many different financial services for the user. Examples of some services includes credit card load, debit card load, Automated Clearing House (ACH) load, ACH unload, person-to-person (P2P) payment, remote pay (RPAY), viral payment and registration, person-to-merchant (P2M), and referrals. Other services can include automated teller machine (ATM) network load and unload. The system can also include bill pay integration, where a user can pay bills such as a cable bill, electricity bill, Internet service bill, telephone bill, housekeeping service bill, and other bills.

Loading of an account refers to transferring of funds to an account on the mobile payment system from which the funds can be used in transactions. For example, a user can load funds from a checking account or credit card to the user's mobile payment system account, which can be managed by financial partner or managed by the operator of the mobile payment system.

Unloading of an account refers to transferring of funds from the mobile payment system to another account. For example, a user can unload funds from the user's mobile payment system account, which can be managed by financial partner or managed by the operator of the mobile payment system, to a checking account or credit card.

Loading and unloading can be performed in any of the ways discussed in this application including through ACH, ATM, or payment card networks. In another implementation, the system allows load and unload from only one or from more of these, such as from ACH, ATM only or, payment card networks

The mobile person-to-person payment system further provides a platform for one or more financial partners, shown at 700 and 705. These partners can include acquirer partners; bank or other financial institutional partner; prepaid processing partner; and an ACH partner. The mobile payment system can also interface with point of sale (POS) systems.

A person skilled in the art will recognize that a number of combinations of partners, services and transactions can be implemented ranging from closed loop single participants to open-loop services with interaction with a wide range of funding accounts as has been described above. For each type of partner (e.g., debit card, credit card, prepaid card, linked deposit account, etc.), there can be multiple such partner entities that interface with the mobile payment system or network and participate in the processing of transactions.

Each partner system can have a different electronic interfacing scheme, and the mobile payment system will communicate using the appropriate application program interface (API) for each partner. A system of the invention allows easy integration of financial partners (e.g., banking partners, payment services partners such as payment card networks, ATM networks, or other payment processors) to mobile and other consumer partners (e.g., mobile phone carriers).

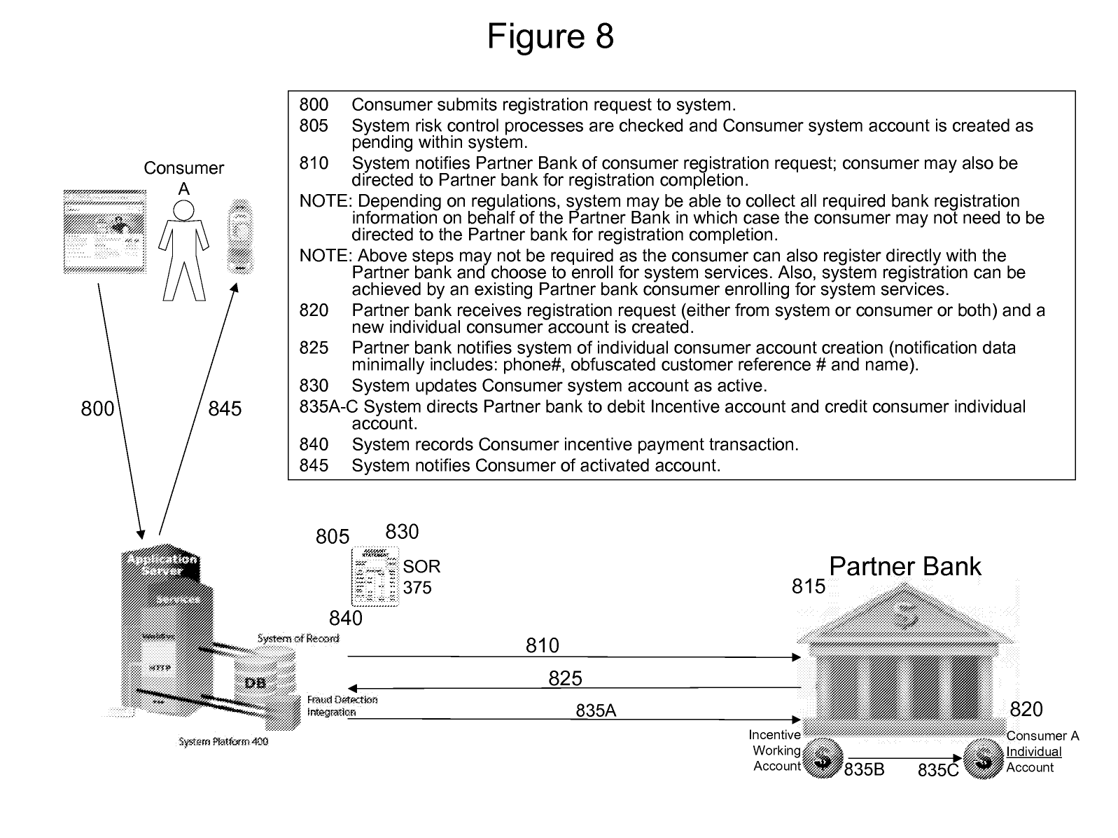

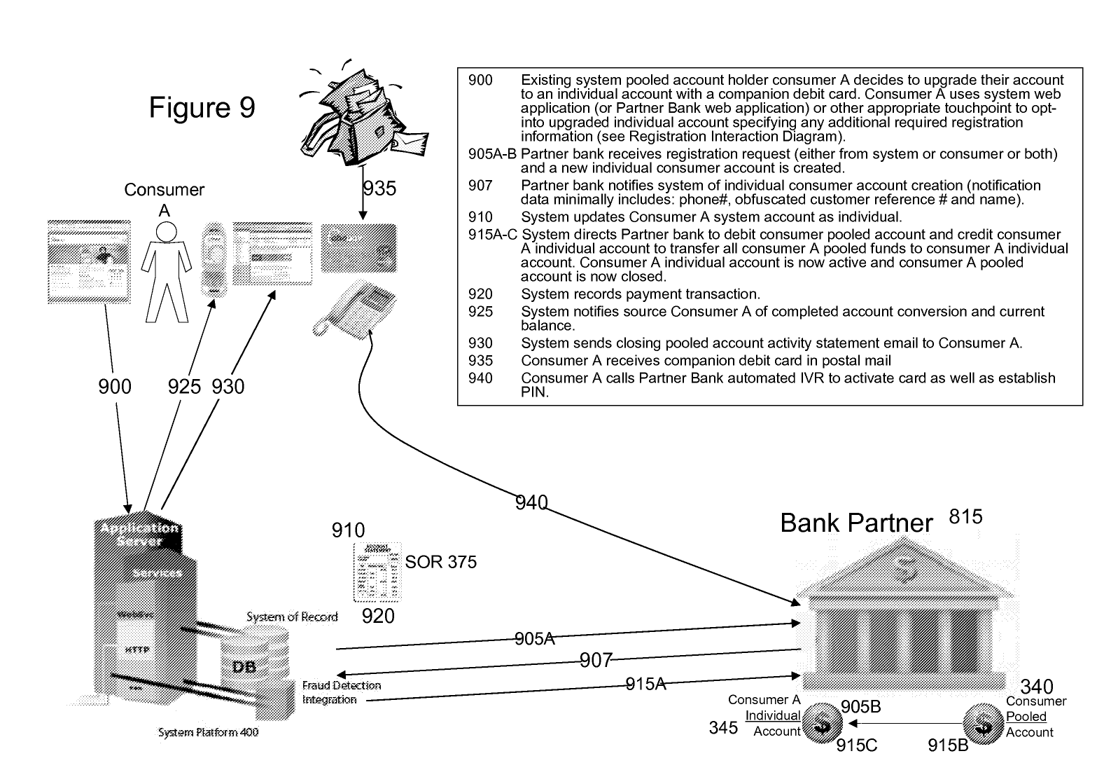

To perform transactions, users, whether individuals or merchants, must be registered with the system in at least some embodiments. The registration process can be appreciated from FIG. 8, in which a consumer A begins the registration process at step 800 by submitting a registration request to the payment system. The system risk engine 655 performs appropriate risk control processes, and, if passed, an account is created for consumer A at step 805 and entered into the system of record 375. At step 810, the system then notifies a partner bank 815 of the registration request. In some embodiments, Consumer A is also directed to the partner bank to provide appropriate registration information, while in other embodiments, the payment system will be able to collect all needed information without redirecting the consumer to the financial institution. In yet other embodiments, consumer A can register directly with the financial institution. In still other embodiments, an interface to a third party system is used to validate registration information. In either event, the partner bank 815 receives the registration request and an individual consumer account is created at step 820. At step 825, the bank 815 notifies the system 400 that an account has been created for consumer A. The SOR (System of Record) 375 is then updated at step 830 to reflect the creation of consumer A's account at the bank 815. In some embodiments, where incentives or similar payments are provided, at steps 835A-C, the system 400 notifies the bank 815 to debit the incentive account 330 maintained at that bank, and to credit consumer A's new account with the appropriate incentive amount. Likewise, in embodiments where referral fees are paid, appropriate debiting and crediting occurs. Then, at step 840, the SOR is updated to reflect the incentive and other payments, followed at step 845 by the system 400 notifying consumer A that his account has been activated. In some instances, a consumer will not desire to open an individual account, in which case his funds will be maintained in a pooled account 340 at an appropriate financial institution. However, the consumer may desire to upgrade their account to obtain a debit or other payment card for the purpose of accessing their funds in more ways, which is typically available in an embodiment only by the establishment of an individual account. In such instances, as shown in FIG. 9, at step 900, the consumer submits a request to upgrade via any convenient means and provides appropriate information to the system 400. At steps 905A-B, the system 400 notifies the bank 815 of the request, and a new account is created at the bank. The bank notifies the system 400 of the creation of the new account at step 910, and the system 400 updates the SOR 375 to reflect that consumer A's account is now individual. Then, at steps 915A-B-C, the system notifies the partner bank to move funds from the pooled account 340 to consumer A's individual account, one of the individual accounts 345. In addition, consumer A's pooled account is “closed” by changing or deleting the ledger entry for consumer A in the pooled account. The money movement is recorded in the SOR at step 920, after which consumer A is notified of the account creation at step 925. The system also provides notice to consumer A of the “closing” of his portion of the pooled account, shown at step 930. In due course, a debit or other card may be provided to consumer A, as shown at step 935, and the card is activated by any convenient means, including IVR, as shown at step 940.

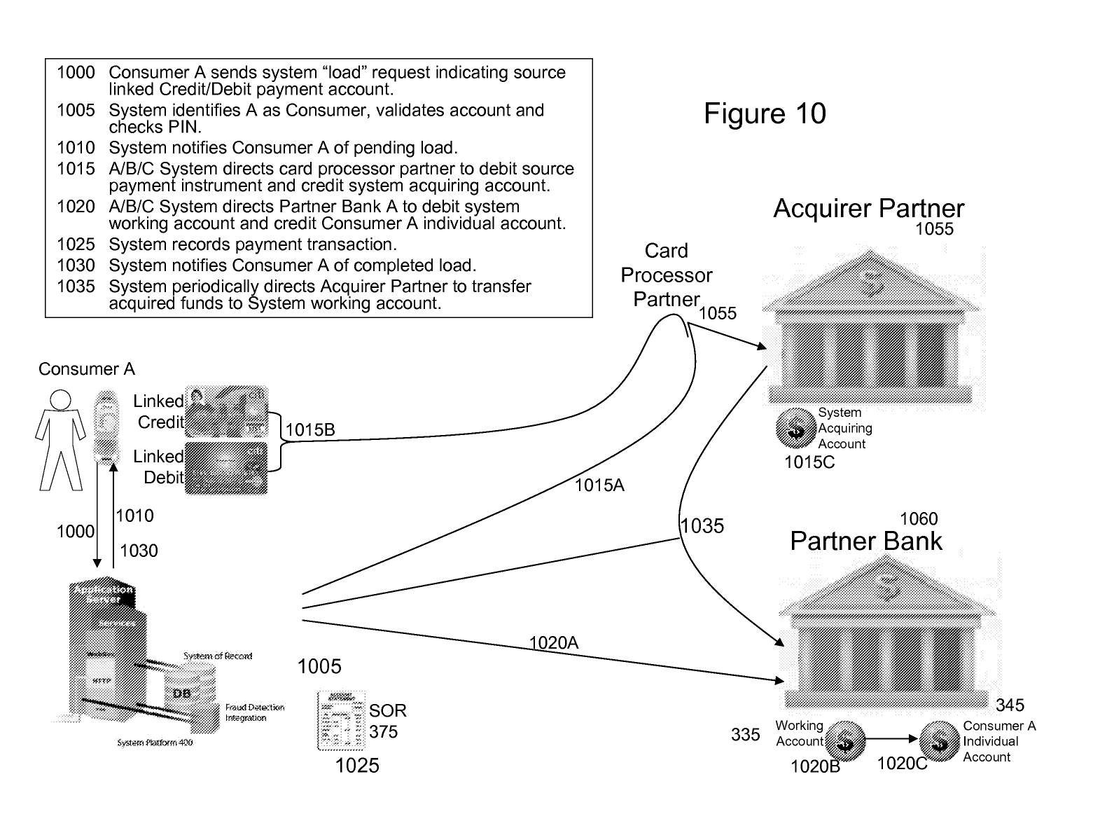

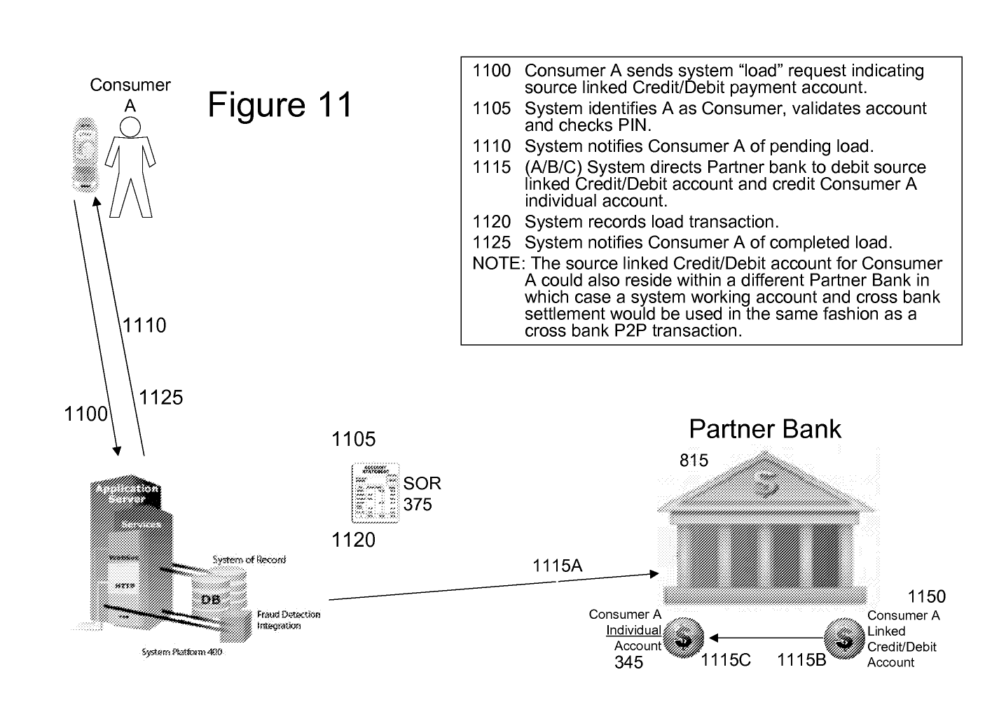

To perform transactions, consumers must add funds to their accounts. This process can be better understood from FIGS. 10 and 11. In FIG. 10, a “load” is performed using a linked credit or debit card and a card processor partner; in FIG. 11, a load is performed from a credit/debit account maintained within a partner bank.

In accordance with FIG. 10, a consumer desiring to add funds to his account sends to the system 400 a load request at step 1000, indicating the source of funds as the linked credit/debit account. The system uses the SOR 375 to authenticate consumer A, typically by verifying a PIN or other indicia, and to validate the account, shown at step 1005. The system 400 then notifies the consumer of the pending load, shown at step 1010, followed at steps 1015A-B-C by the system notifying the card processing partner 1050 to debit the source of funds and to credit the acquiring working account 335, which the card processor does. At step 1020A-C, the associated acquirer partner bank 1055 is notified to debit the system working account 335 and credit consumer A's individual account 345 at partner bank 1060. The crediting transaction is then recorded in the SOR 375, shown at step 1025, after which the system 400 notifies the consumer of the completed load at step 1030. In addition, but only periodically or as otherwise provided by a particular embodiment, at step 1035 the system directs the acquiring partner bank 1055 to shift funds to the system working account to maintain appropriate working balances.

FIG. 11 reflects a somewhat simpler load process, where the source of funds and the consumer account are held at the same institution. At step 1100, the consumer sends a load request, indicating as the source of funds a linked account 1150. The system 400 verifies the authenticity of the request and the account, step 1105, and then notifies consumer A of the pending load at 1110. At 1115A-C, the system 400 directs the partner bank to debit the source of funds, and credit consumer A's individual account. The load transaction is then recorded at step 1120, followed by notifying consumer A of the completed load at step 1125.

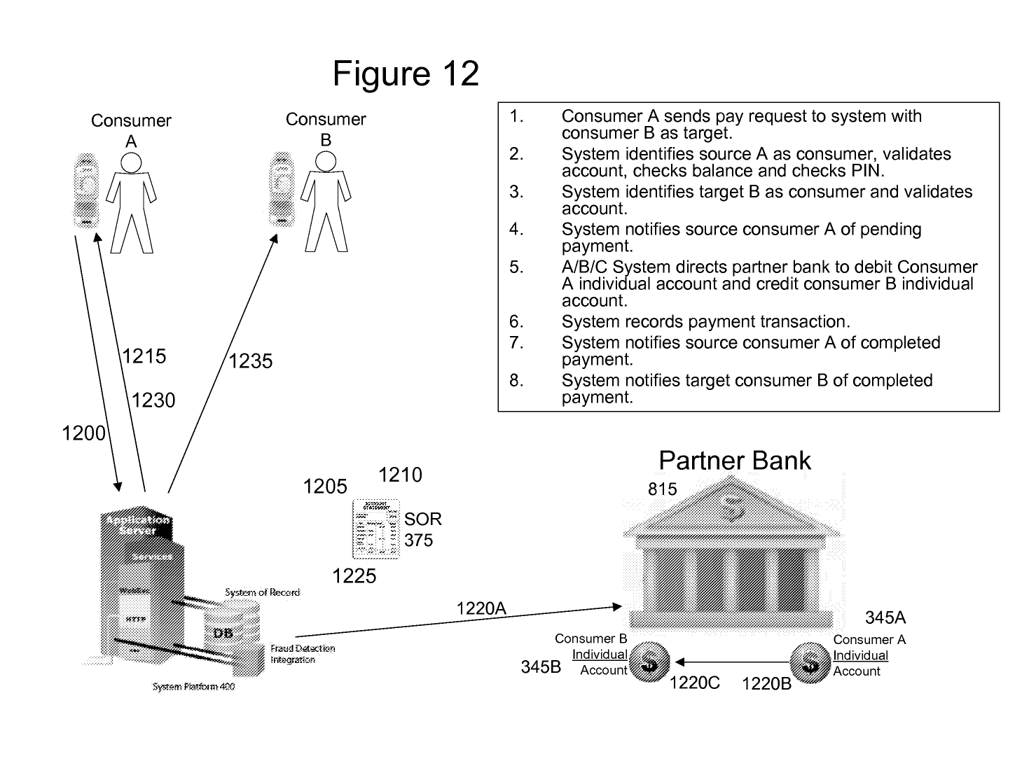

At this point, consumer A is registered and has funds in his system account. He is now able to perform transactions with others. FIG. 12 describes a typical payment using the system of the present invention for a payment to another individual, consumer B, where consumer B is already registered with the system 400. In its simplest form, both consumer A and consumer B have individual accounts 345A and 345B at a single partner bank 815. In such an arrangement, consumer A sends a payment request to the system at step 1200, identifying consumer B as the target, as well as the amount of payment plus any appropriate authentication credential, such as a PIN. The system verifies the authenticity of the instruction at step 1205, followed at step 1210 by identifying the target as consumer B and validating consumer B's account. Consumer A is then notified by the system of the pending payment, at step 1215. At steps 1220A-C, the partner bank 815 is directed to debit A's account 345A, and credit B's account 345B. The transaction is recorded in the SOR 375 at step 1225, after which consumers A and B are notified of the completed payment at steps 1230 and 1235, respectively. At this point the transaction is processed for settlement, or clearing according to the messaging requirements of the particular network. Various messages may be sent and received as part of this process. It will be appreciated that, in some implementations of the system for this transaction and those discussed subsequently herein, the SOR 375 can be distributed, or multiple SOR's can exist, such that one SOR may reflect only those transactions conducted through system 400, with an additional or primary SOR resident at a partner financial institution or network providing a full history and balance of all transactions involving the accounts of the consumers. The location of the primary SOR is not critical for the operation of the present invention, and the SOR 375 is intended to illustrate the SOR functionality regardless of location.

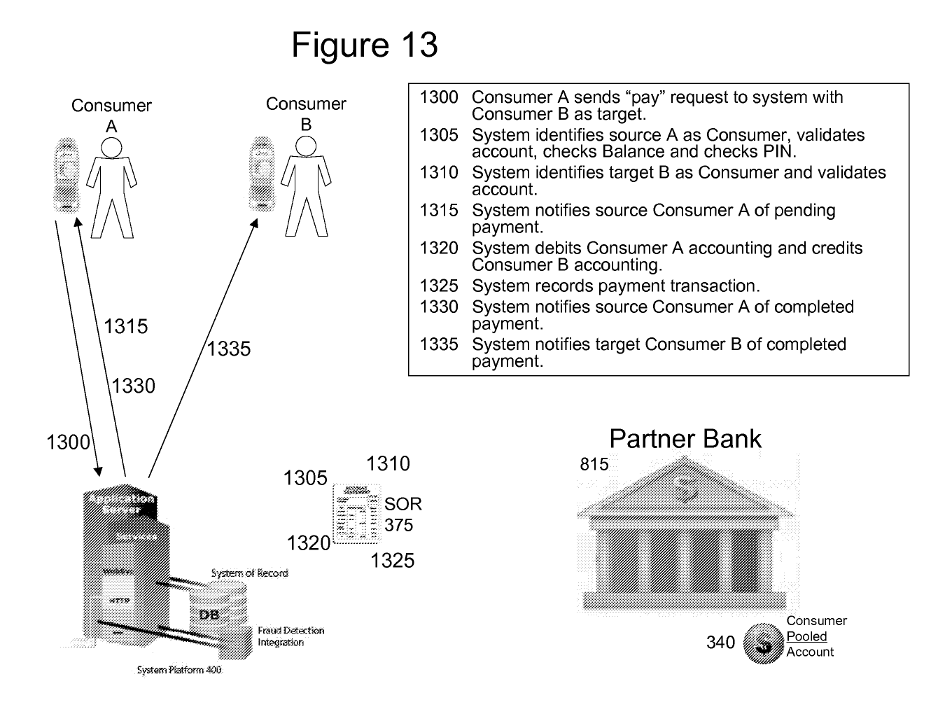

FIG. 13 reflects situations where neither user has an individual account, in at least some embodiments their funds are maintained in trust for them in a pooled account 340 maintained at the partner bank 815. P2P transactions can still be performed, as shown in FIG. 13. At step 1300, consumer A sends a pay request to system 400, identifying consumer B as the target. As before, at step 1305 the instruction is authenticated, after which, at step 1310, consumer B is validated as an authentic target. Consumer A is notified of the pending payment at step 1315. Then, because the funds are maintained in a pooled account 340, no funds movement actually occurs, but instead the SOR applies appropriate debits and credits to the ledger, or “T” accounts of consumers A and B to reflect the payment. Then, at steps 1330 and 1335 respectively, the parties are notified of the completed transactions.

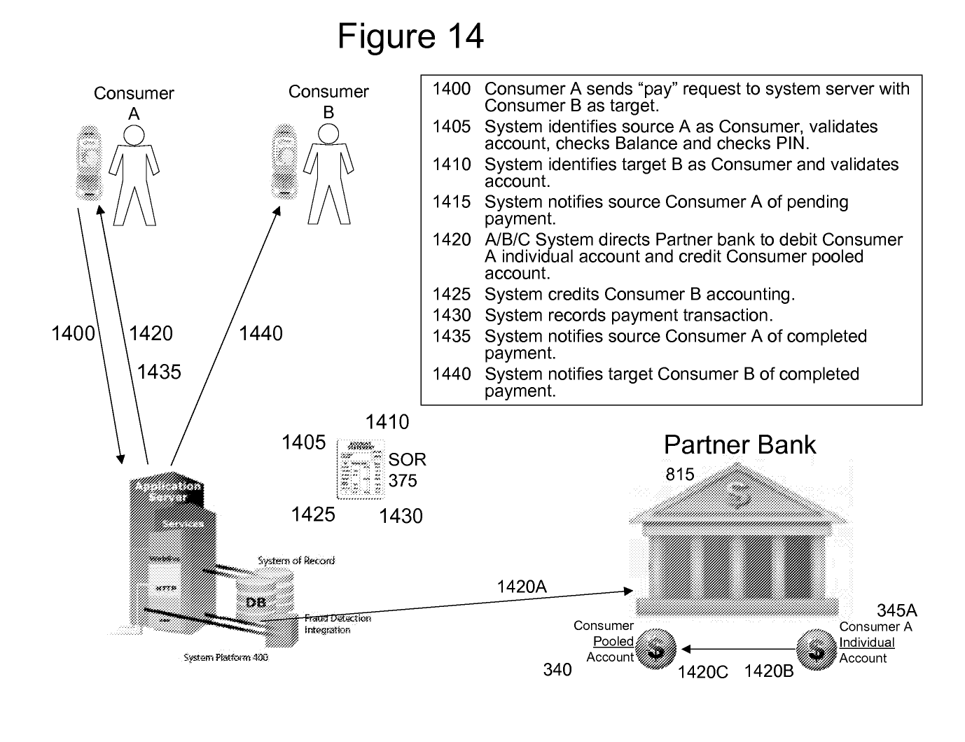

FIG. 14 illustrates one embodiment of a transaction where sending consumer A has an individual account and receiving consumer B's fund are maintained in a pooled account. In the illustrated embodiment, at step 1400 consumer A sends a pay request to the system 400, identifying consumer B as the recipient or target of the funds. At step 1405, the system uses SOR 375 to identify the source of consumer A's funds, validates the account and balance, and checks appropriate security information including PIN and other anti-fraud or security information

Then, at step 1410, consumer B is identified using the SOR and her account is validated, followed at 1415 by notification to consumer A that the payment is pending. Next, at 1420, the system directs partner bank 815 to debit consumer A's individual account and, at 1425, to credit consumer B's ledger account in system pooled account 340, after which the transaction is recorded in SOR 375 at step 1430. Finally, at steps 1435 and 1440, consumers A and B are notified of the completion of the transaction.

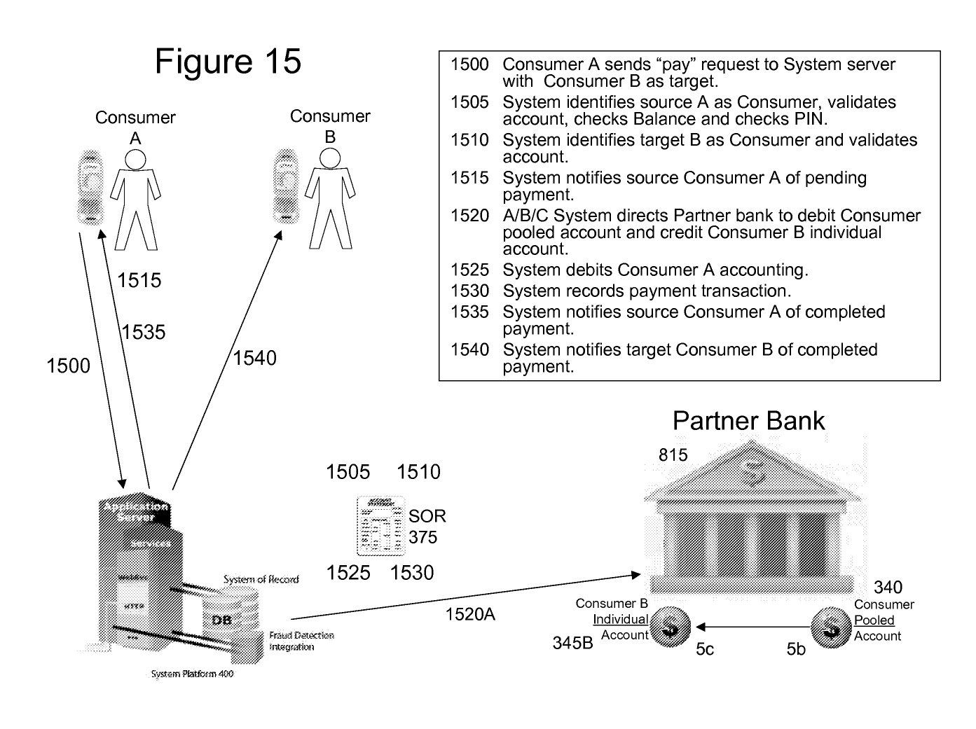

FIG. 15 illustrates the mirror of FIG. 14, and reflects the situation where consumer A maintains his funds in a pooled account, while receiving consumer B maintains his funds in an individual account. In this arrangement, consumer A sends a pay instruction at step 1500, after which the system 400 uses SOR 375 to identify consumer A, validate his account, etc. as before, as indicated at 1505. Then, at step 1510, consumer B is identified as the target his account is validated. Next, at 1515, the system notifies consumer A of the pending payment, after which, at 1520 and 1525, the system directs partner bank 815 to debit the ledger account for consumer A maintained within system pooled account 340 maintained at bank 815, and to credit consumer B's individual account 345. It will be appreciated that, in some embodiments, the particular order of 1520 and 1525 is not critical to the reliability of the system as long as no significant delay occurs between these steps and, since they occur within the same system, they can occur within moments of one another. The payment transaction is recorded in SOR 375 at step 1530, followed at 1535 and 1540 by providing notice to consumers A and B of the completed transaction.

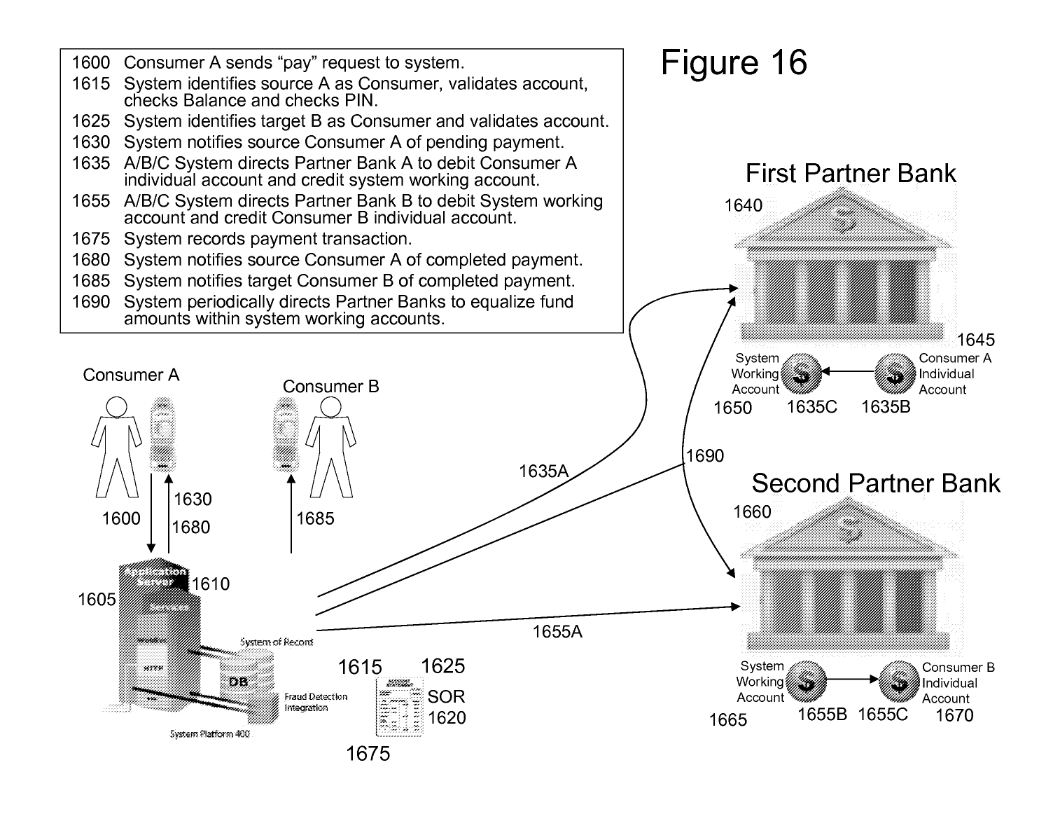

Referring next to FIG. 16, an embodiment of a cross-bank P2P transaction is shown with bilateral settlement. In such an embodiment, at step 1600 consumer A sends a pay request to the system of the invention, indicated at 1605, which comprises an application server 1610 performing appropriate services as previously described. At step 1615, the system accesses system of record database 1620 and identifies consumer A's source of funds, validates the account, checks the balance, and checks the user's PIN as well as any other security and anti-fraud features. It will be appreciated that SOR 1620 can reside on any appropriate server, including those of the financial institution, a card processor, or a financial network. Similarly, the funds transfer can be processed directly on the system of the present invention or through any suitable network, including partnering relationships directly with financial institutions or through other networks such as a payment card network, ATM network or ACH network.

Then, at step 1625, the system identifies consumer B as the recipient, or “target”, of the funds and validates consumer B's account, again using the SOR database 1620. The system 1605 then notifies consumer A of the pending payment at step 1630, and at step 1635 issues instructions to a first partner bank or other financial institution, indicated at 1640, to debit consumer A's account, indicated at 1645, and credit working account 1650 associated with the system 1605.

Next, at step 1655, the system issues instructions to a second partner bank or financial institution 1660 to debit the system working account 1665 maintained at that institution and credit consumer B's individual account 1670. The system then updates SOR 1620 to reflect the transaction, shown at step 1675, following by sending notices to consumers A and B, as indicated at steps 1680 and 1685. It will be appreciated that the particular order in which the notices are provided can vary depending upon implementation, and can occur slightly before the transaction completes, or afterward. Periodically, as shown at step 1690, the system directs partner banks 1640 and 1660 to equalize the fund amounts within the system working accounts 1650 and 1665. In some implementations, the balancing will occur across a multitude of working accounts maintained at a large number of financial institutions.

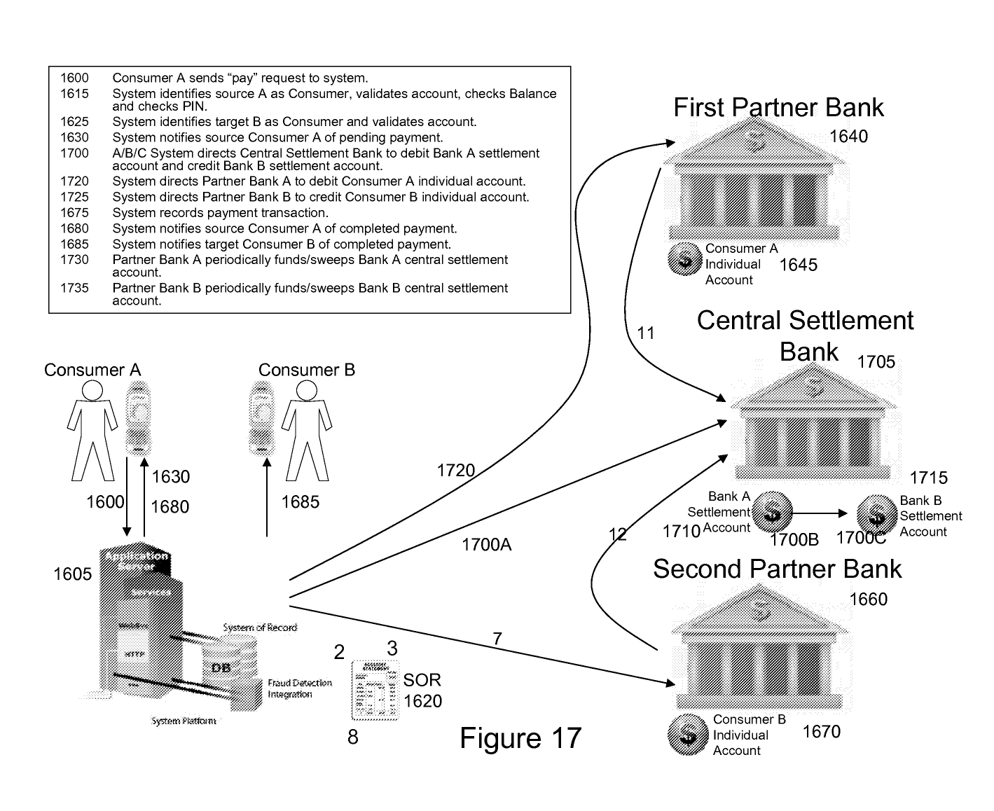

FIG. 17 describes an embodiment of the invention wherein a cross bank transaction where a central settlement institution, sometimes referred to as a “wholesale” bank, is used. In the embodiment of FIG. 17, consumer A sends a pay request 1600 to the system 1605, followed at step 1615 by the system verifying consumer A, validating his account, and checking the balance in the SOR 1620. As with FIG. 16, at step 1625 the system identifies consumer B, the recipient, and validates her account. Then, at step 1700, the system issues instructions to a central settlement bank 1705 to debit a settlement account 1710 of first partner bank 1640 maintained at bank 1705, and to credit a settlement account 1715 of second partner bank 1660 maintained at bank 1705. Next, shown at step 1720, the system directs partner bank 1640 to debit consumer A's account maintained at that bank, and then in step 1725 directs second partner bank 1660 to credit consumer B's account maintained at that bank. The SOR 1620 is then updated, wherever it happens to reside, followed by appropriate notices being sent to consumers A and B, as shown at steps 1680 and 1685. Periodically, partner bank 1640 either funds or sweeps its settlement account 1710, as shown at step 1730. Likewise, second partner bank 1660 periodically either funds or sweeps its settlement account 1715, as shown at step 1735. It will be appreciated by those skilled in the art that the various instructions required for managing such transfers can be issued to a payment card network, ATM network, ACH network or any similar system or network which has access to appropriate accounts at the wholesale bank, or to appropriate commercial accounts maintained at any financial institutions.

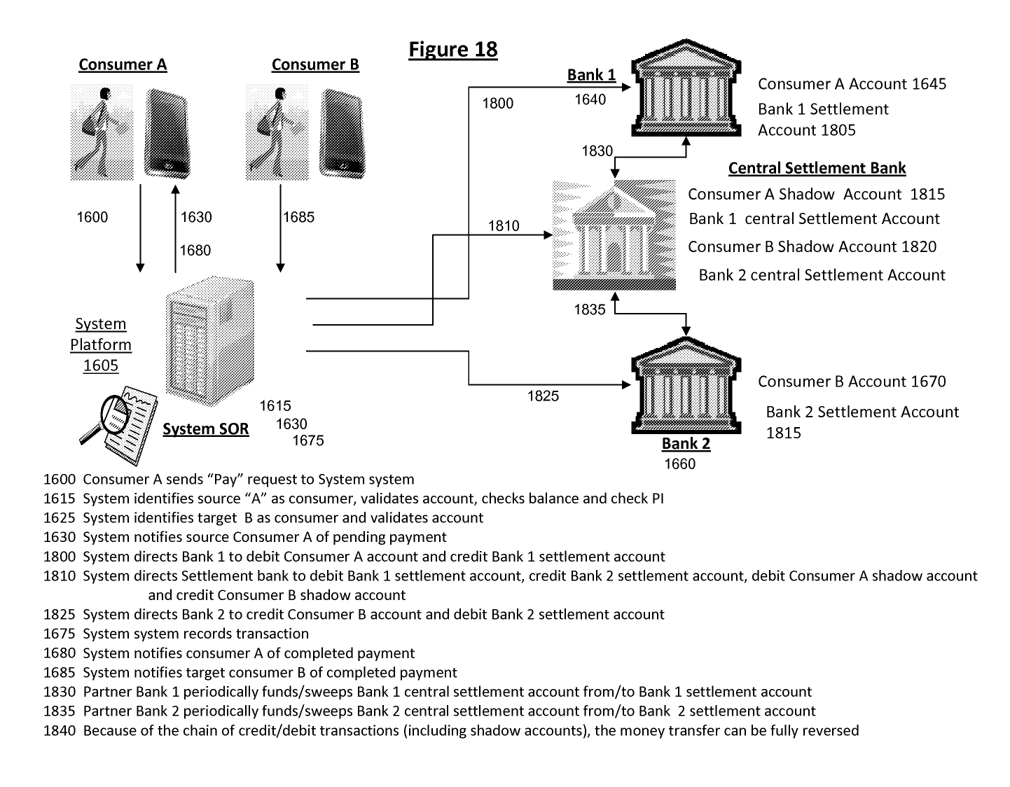

Turning next to FIG. 18, a variation on the central settlement transaction of FIG. 17 is shown, wherein the transaction can be reversed through the use of shadow accounts maintained at the central settlement bank for each participant in a transaction handled by that settlement bank. As shown at step 1600, consumer A sends a pay request to the system 1605. The system identifies the customer, etc., as at step 1615, and identifies the recipient at step 1625. Consumer A is notified of the pending payment, shown at step 1630.

Then, at step 1800, the system issues instructions to first partner bank 1640 to debit consumer A's account 1645 and credit the system's settlement or working account, indicated at 1805, maintained at bank 1640. Next, at step 1810, the system directs a central settlement, or wholesale, bank 1705 to debit the first bank settlement account 1805 and credit the system's settlement account 1815 maintained at a second partner bank 1660, where consumer B's account is maintained. In addition, the bank 1705 maintains a shadow account for each consumer, or alternatively each consumer who conducts a transaction that passes through bank 1705, similar to a general ledger T account but needing only information about transactions. As part of step 1810, the system directs the settlement bank 1705 to debit consumer A's shadow account 1815 and credit consumer B's shadow account 1820. At step 1825, the system directs the second partner bank 1660 to credit consumer B's account 1670, and debit the system's settlement/working account 1815 maintained at that bank.

At that point the transaction is recorded in the SOR 1620, shown at step 1675, followed by notifying consumers A and B of the transaction's completion, shown at steps 1680 and 1685. It will be appreciated that the order of these steps is not critical, and the notification can occur contemporaneously, or even slightly before, the actual crediting of consumer B's account, since the most important step for this aspect is the debiting of funds from consumer A's account. Finally, the system directs partner banks 1 and 2 to periodically fund or sweep their respective central settlement accounts 1815 and 1820 maintained at settlement bank 1705 as shown at steps 1830 and 1835. Because of the shadow accounts maintained at settlement bank 1705, a complete record of the transaction exists at the settlement bank. Should the transaction fail for any reason or need to be cancelled, the information maintained at the settlement bank 1705 permits the transaction to be rolled back, or reversed, in full.

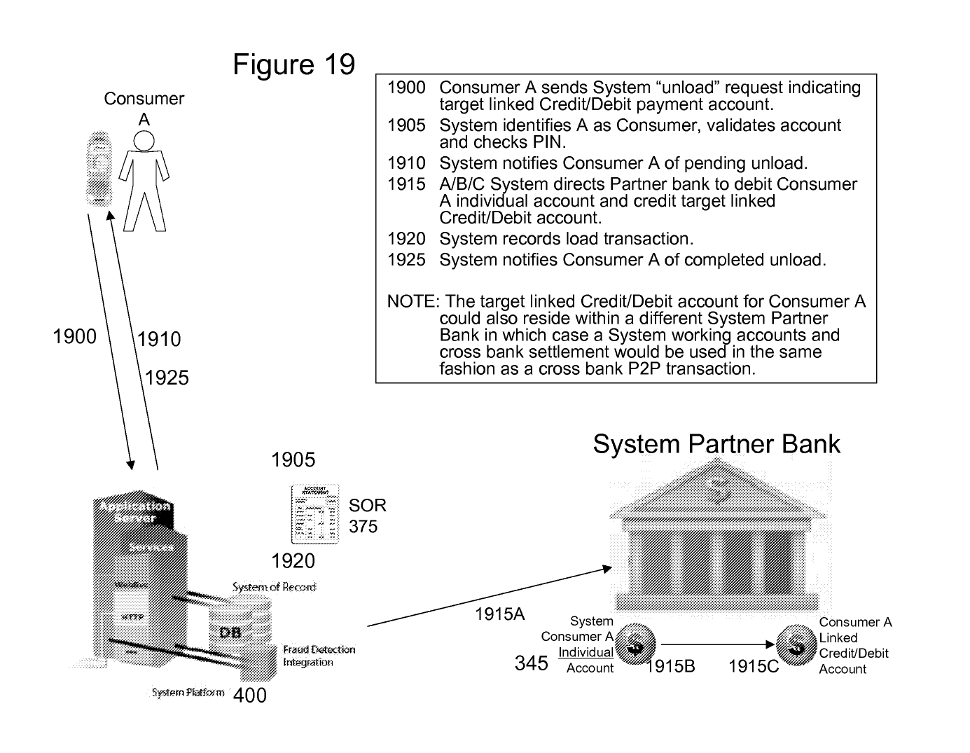

Referring next to FIG. 19, an embodiment of an unload process is illustrated, showing how a consumer can access funds in his system account. As shown at step 1900, consumer A sends an unload request to system 400, the request is authenticated at 1905, and the consumer is notified of the pending unload at 1910. The partner bank is then directed to, and does, debit consumer A's account and credit consumer A's targeted linked account, shown at 1915A-C. The SOR 375 records the transaction, step 1920, and notifies consumer A of the successful unload at step 1925. It will be appreciated that cross-bank unloads can also occur, in which case the unload process is essentially similar to the cross-bank settlement steps shown in FIG. 17.

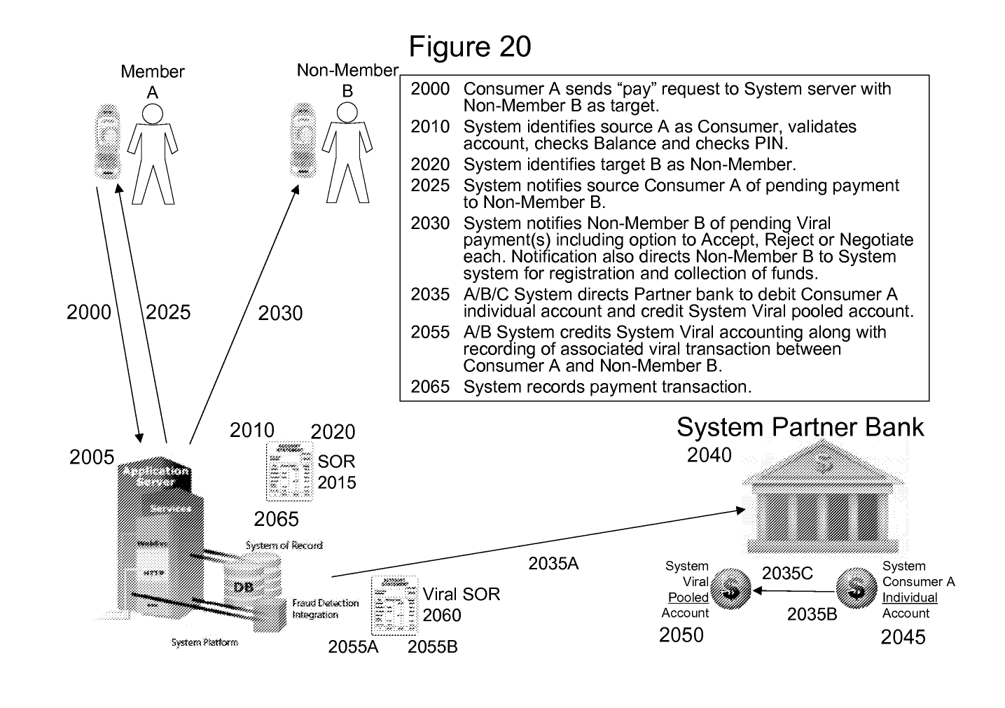

Referring next to FIG. 20, an embodiment of a viral transaction is shown. As shown at step 2000, consumer A sends a pay request to the system 2005, identifying non-member B as the recipient of the funds. Then, at step 2010, the system identifies consumer A, validates his account and balance using SOR 2015, and performs appropriate authenticity and antifraud checks. At step 2020, the system identifies the recipient, consumer B, as a non-member, again using SOR 2015.

Next, at step 2025, the system notifies consumer A of the pending payment, and in some embodiments also identifies recipient B as a non-member. Then, at step 2030, the system notifies consumer B of the pending payment from consumer A, and offers to consumer B the options of accepting or rejecting the payment, and, in some embodiments, the additional alternative of negotiating with the sender. The notice typically also provides instructions to non-member B for how to receive his funds, including the opportunity to register with the system of the present invention.

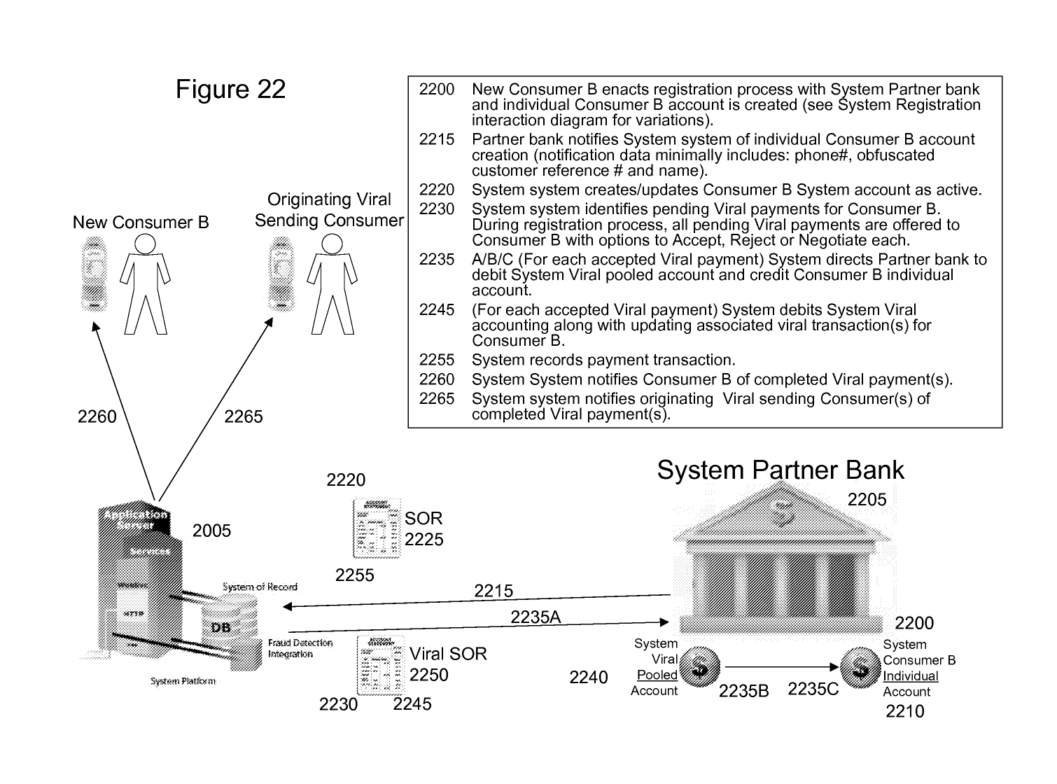

As indicated at step 2035, once consumer B either registers (see FIG. 22) or arranges to pick up his funds without registration, the system directs partner bank 2040 to debit consumer A's account 2045 and to credit a viral pooled account 2050 maintained by the system at bank 2040. Then, as shown at step 2055, the system creates a T account for consumer B and enters a credit for him in a viral SOR 2060, and records the viral transaction. Upon completion, the transaction is recorded in SOR 2015, as shown at step 2065.

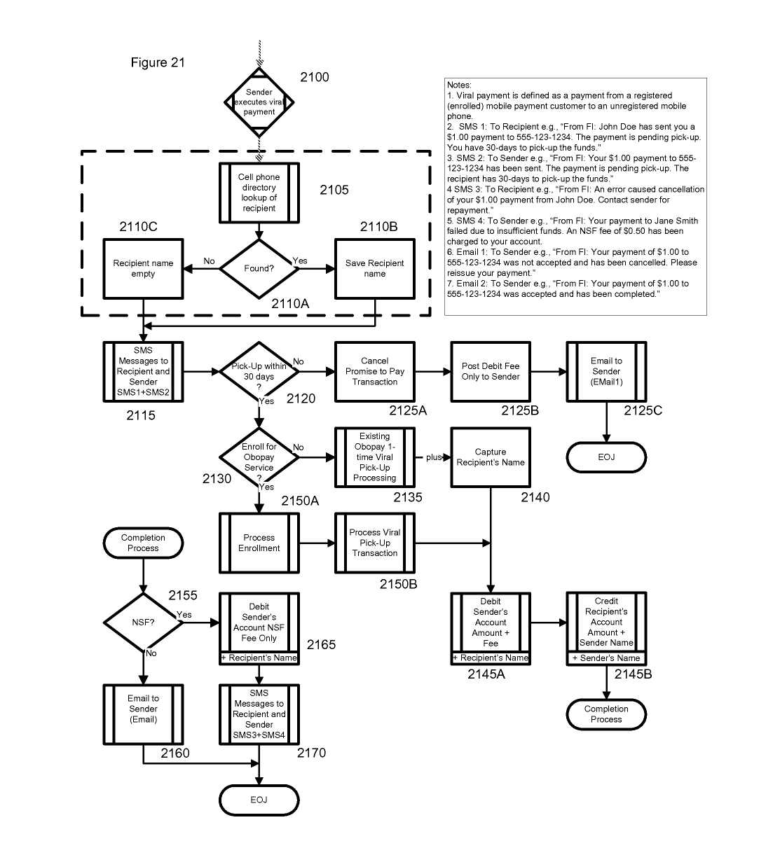

Referring next to FIG. 21, an alternative to the viral process of FIG. 20 is illustrated. In the embodiment of FIG. 21, consumer A sends a pay request at step 2100, identifying the recipient by his cell phone number. At step 2105, the system attempts to identify consumer B through the cell phone number and either finds the number and associated data or not, as shown at steps 2110A-C. The system then messages both sender and recipient that consumer A is attempting to send funds to consumer B, indicated at 2115. In a typical arrangement, the recipient is given a limited period to pick up his funds, as indicated at 2120. If the recipient fails to arrange for pickup within that period, the transaction is canceled, any fees returned to the sender's account, and the sender is notified, as indicated at 2125A-C.

However, if the recipient does arrange to pick up the funds, either by arranging for one-time pickup or by enrolling or registering with the system as shown at 2130, the transaction goes forward. If the recipient elects a one-time pickup, shown at 2135, the system obtains the recipient's name and any additional data necessary for verification of identity and related OFAC information, as indicated at step 2140. Once consumer B provides that information, consumer A's account is debited and a T account created for recipient B is credited, as shown at 2145A-B. If consumer B enrolls, the enrollment is processed at step 2150A followed by processing a viral pick-up transaction shown at 2150B. At this point the completion process begins, and consumer A's account is checked at step 2155 for sufficient funds to complete the promise to pay. If there are sufficient funds, the process advances to sending a completion email to consumer A, shown at 2160. If the check at 2155 indicated a lack of funds, consumer A's account is debited only for an NSF charge, the transaction fails, and consumers A and B are messaged accordingly, as shown at 2165 and 2170.

Referring next to FIG. 22, an embodiment of a viral registration process in accordance with the invention can be better appreciated. At step 2200, unregistered (or unenrolled) consumer B initiates a registration process through, for example, a partner bank 2205, resulting in the creation of an account 2210 for consumer B. The partner bank 2205 notifies the system of the account creation and provides appropriate identifying information, for example phone number, name, and other reference data, as indicated at 2215. Next, at 2220, the system updates SOR 2225 to add consumer B's account, followed at 2230 by notifying consumer B of pending viral payments. In some embodiments, consumer B is offered the option of negotiating, accepting or rejecting the payment.

For each accepted viral payment, at step 2235 the system directs the bank 2205 to debit a viral pooled account 2240, followed at step 2245 by updating a viral SOR 2250 maintained by the system. Next, at step 2255, the transaction is recorded in SOR 2225, followed by transmission of notices to consumers B and A of the completed viral payments, shown at steps 2260 and 2265.

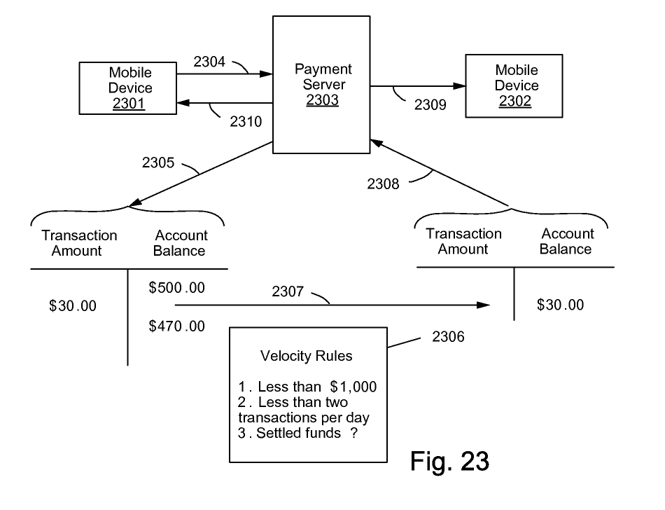

FIG. 23 shows the transaction flow in an embodiment of the payment system of the present invention. When a payment is made from a mobile device 2301 to another mobile device 2302, the request for the transfer is passed to the payment server 2303. The request is indicated by reference arrow 2304. Server 2303 accesses the T-ledger for the account holder associated with mobile device 2301, indicated at 2305, and transfers the specified amount to a payee T-ledger (as indicated by reference arrow 2307) if certain velocity rules are met as indicated at 2306 and discussed hereinafter. Once funds have been transferred to the payee, as indicated by 2308, server 2303 sends a notification message to the payee as indicated at 2309. Finally, the payer account holder receives a confirming message from server 2303 that the transaction has been completed. It will be appreciated that the embodiment illustrated in FIG. 23 can, but need not, be a closed loop system.

In order to get money into and out of the Mobile payment system, the present invention provides for three types of functions for different account holders representing different levels of risk.

Some account holders will already have a bank account with a bank that is not a partner. The system allows account holders to move funds to and from this bank account through the ACH system or through a direct integration with the account holder's DDA or through an integration through participating ATM networks or payment card networks. Due to the risks and regulations involved, the user can be subjected to risk controls that can include deferred availability of transferred funds. This deferral time could be reduced with additional underwriting (e.g. running credit reports or obtaining financial statements). Where the account holder enrolled as a result of a relationship with a partner bank, a real time connection to the Demand Deposit Accounting (checking account) system enables the account holder to obtain balances and post transactions to their account in real time.

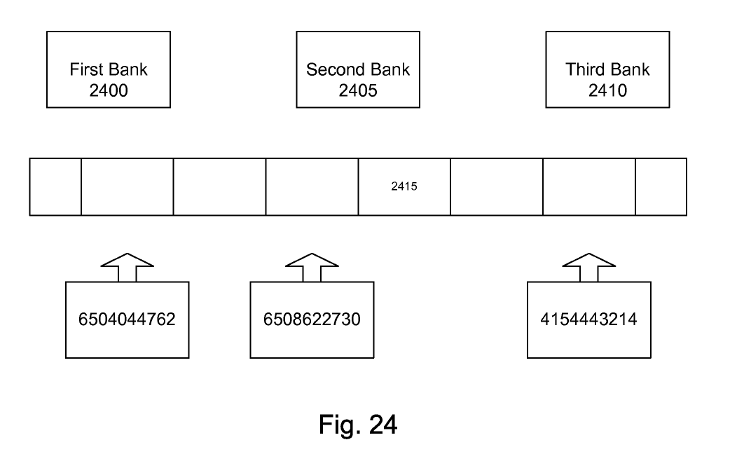

Referring to FIG. 24, in an embodiment of the invention that avoids the need to keep general ledgers for each bank, the mobile payment system can keep one general ledger for the virtual pooled account for each country, region or other suitable grouping. This reduces the settlement and operational costs of the system. Since money will be held in the virtual pooled account, the owner of the virtual pooled account (e.g., the mobile payment system service operator) will receive the float or interest on this money. The recipient of the float on the virtual pooled account can distribute some amounts to the partner banks (who are no longer receiving the float on their general ledgers).

An exemplary method for distributing the float funds is as follows:

(1) Accounts that are acquired by the partner bank will be recognized as coming from that bank. For example if bank 2400 markets the mobile payment system service and recruits customer A then customer A for its lifetime will be marked as “Recruited by bank 2400.” For each user record (discussed elsewhere in this application), there can be a field indicating from which source that particular user was recruited from. Some examples of possible sources include the mobile payment service directly, partner bank, partner financial institution, and partner mobile phone provider.

At the end of each settlement period the mobile payment system service will estimate the amount of funds held in the mobile payment system service accounts that are marked as recruited by each partner bank. For example, in FIG. 24, member 6504044762 was recruited by first bank 2400 while member 4154443214 was recruited by third bank 2410. In this example, the members are identified by phone number. As has been stated elsewhere in this application, members can be identified by other types of identifiers, such as instant messenger user name, e-mail address, social security number, driver's license number, account number, and others.

Accounts not recruited by a particular bank can also reside in the virtual pooled account. These are accounts that were recruited by mobile payment system service direct or nonbank partners. In FIG. 24, this is represented by phone number 6508622730 which was recruited by the mobile payment system service provider, or MSPS.

From time to time, whether daily, weekly, monthly or on an event-driven basis, the mobile payment system will calculate the appropriate funds to be held in a partner bank. For example, it can calculate the amount due to the bank for those accounts it recruited (“X”, for convenience), plus a percentage of the non-recruited accounts (“Y”, for convenience).

This method is designed to avoid the cost of keeping multiple general ledgers and exact net settlement. It also will give the partner bank a fair share of mobile payment system service funds.

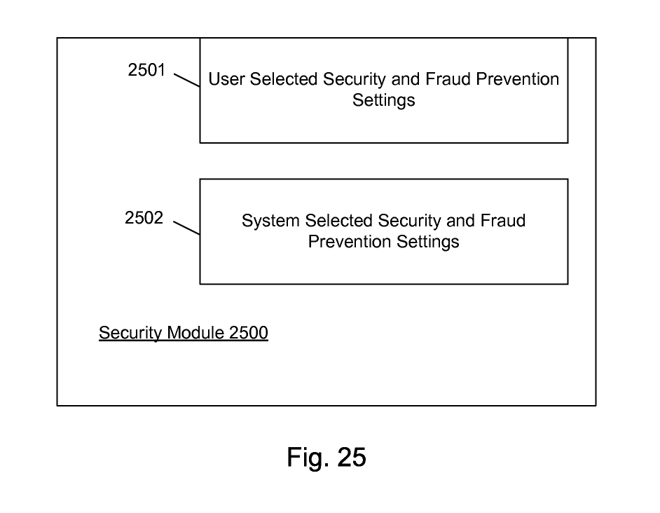

Referring now to FIG. 25, a tiered fraud detection system 2500 is illustrated as part of transaction processor 200 (FIG. 2). The first tier of the tiered system 2500 includes a rules based engine and user selected components 2501. The second tier of the tiered system 2502 includes proprietary components that are not accessible or visible to the account holders. The second tier can comprise security components that accommodate not only different levels of risk management for different types of consumers, but also comprise different levels of risk management for different classes of partners of the system.

User selected components include, for example, the ability of the account holder to customize security for their account. For example, in an embodiment account holders can link the cell phone number for family members that are authorized to access the prepaid account. As another example, for each designated phone number, the account holder can specify maximum spending limits on a daily, weekly, or monthly basis. Still further, the account holder can exclude certain merchants, account numbers or telephone numbers by creating a personal “black list” for the designated excluded parties.

A specific black list implementation allows the account holder to designate wild card exclusions such as blocking transfer of funds to any phone having a particular area code or to any “900” or foreign number. The account holder can create a separate personal black list for an authorized user. This feature is particularly useful to control improper spending by cell-phone-equipped children. Any number of numbers or accounts can be included on the black list.

Conversely, in an embodiment the account holder can also specify a “white list” of only the certain merchants or telephone numbers that can be included in a financial transaction that involves one of the authorized users. All other merchants and telephone numbers can be optionally deemed to be on the personal black list. Again, this feature is particularly useful to control the spending of children by allowing purchases for transit, lunch, and school supplies but not for magazines or other novelties.

In addition to specifying the personal black list and white list, the account holder can also preauthorize purchases at each of the merchants appearing on the white list while setting a per transaction limit on the other numbers on the white list.

The account holder can customize a rules-based fraud detection mechanism which is also implemented at the first tier.

In some embodiments, the account holder can also specify the maximum amount for each transaction and the number of transactions that can be processed on a cell phone in a selected period. The account holder can also specify the maximum amount of funds that are to be deposited and retained in the Mobile Payment System account. In some embodiments the transaction processor 200 sweeps excess funds to another designated account, such as a personal savings account, on a daily basis.

The second tier of the tiered system 2502 includes proprietary components that are not accessible or visible to the account holders. For example, in an embodiment the second tier 2502 can include a maximum spending limit based on historical averages, geographical verification, or the historical number of daily transactions. Other rules-based fraud detection and transaction frequency (velocity) control mechanisms are also implemented within this tier.

Other embodiments of the invention can include such security or risk management features as may be required to satisfy the requirements of financial institutions or merchant partners or payment card network partners, and can also include such risk management components as desired to acknowledge the different levels of risk represented by different partners of the system, for example different levels of risk represented by different types or locations of financial institutions, aggregators, and so on. The foregoing discussion concerning limits, white and black lists, and related settings for individual accounts can also be applied to such partners.

Security and fraud prevention are important issues for the payments industry and are a continuing source of problems. The mobile payment transfer infrastructure and method of operation, in accordance with the present invention, are effective tools in addressing these problems. Specifically, the use of the mobile device to conduct financial transactions allows for a real time transaction that uses funds that are guaranteed to be available. The receiving party can verify the validity of the entity holding the funds and that the account has a sufficient balance to conclude the transaction. Advantageously, the account information of the payer (credit card number, debit card number or other account at a financial institution) need not be provided to conclude the transaction.

On the sending side of the transaction, the sending party uses a PIN code or other security credential to authenticate the person with the phone. Such authentication provides a high level of security when used concurrently with the verification by the payment server of the identity of the mobile device (using caller ID or other unique device identifiers). Advantageously, the PIN is transferred in a secured manner and is not stored in the mobile device in a visible form.

Additionally, the transaction can be identified by a unique sequence number that is determined by the mobile client application and is sent as part of the command stream to the payment server. At the payment server, a history of used sequence numbers is maintained, so transactions with previously used sequence numbers will be declined in some embodiments.

If SMS messages are used to complete a transaction, in an embodiment the authorization PIN can be implemented as a verbal code that is spoken into the mobile device and transmitted to the payment server for authentication using voice recognition software.

In an alternative embodiment, certain transactions such as those with merchants can be structured to use an active authorization where the account holder's phone rings with a message to approve the dollar amount transferred. Payment cards and checks cannot operate with this level of interaction. Such techniques can also be implemented when the value of the transaction exceeds a threshold.

Additional security is provided in some embodiments by the use of the PIN code to activate the mobile client application. In this embodiment, the PIN code occurs in a first instance to open the mobile client application and initiate its operation. The same PIN code or, optionally, a separate PIN code is used for authorization of transactions over the network. This dual PIN code process is not available on traditional payment cards, checks or even smart cards.

When fraud is detected, the mobile device can be disabled and prevented from using the network to access the account. In general mobile devices have several key attributes that facilitate future security safeguards. Most if not all of these attributes do not exist on cards. Specifically, the mobile devices include an independent source of power to run physical devices, such as special purpose chips, and a secure case or housing that can house devices like smart chips. Mobile devices allow communication by voice and by data over the cellular network or over the Internet so voice verification and a PIN can be used in combination, or separately, to identify an account holder. Transactions can be initiated and verified by use of voice recognition technology and by data entered through a keyboard. In other embodiments, visual communication is provided through the use of a camera.

Another level of security is provided by the use of location technology, such as a geo-positioning system or GPS can determine the physical location of the device. Thus, if the account holder is using the payment service in an atypical location (such as when they are on vacation), the account user can be authenticated by asking for the PIN to be re-entered or other forms of complementary authentication to be provided. Another advantage of the location technology is that the services made available to the account holder can be adjusted based on where they are located. For example, discounts or special promotions can be sent along with the confirmation for a transaction whenever the location of the account holder matches that of the merchant. In other embodiments, if the account holder is in the area of a merchant that is offering a special discount, a promotional message could be sent to the account holder if authorized by their profile maintained by the payment server.

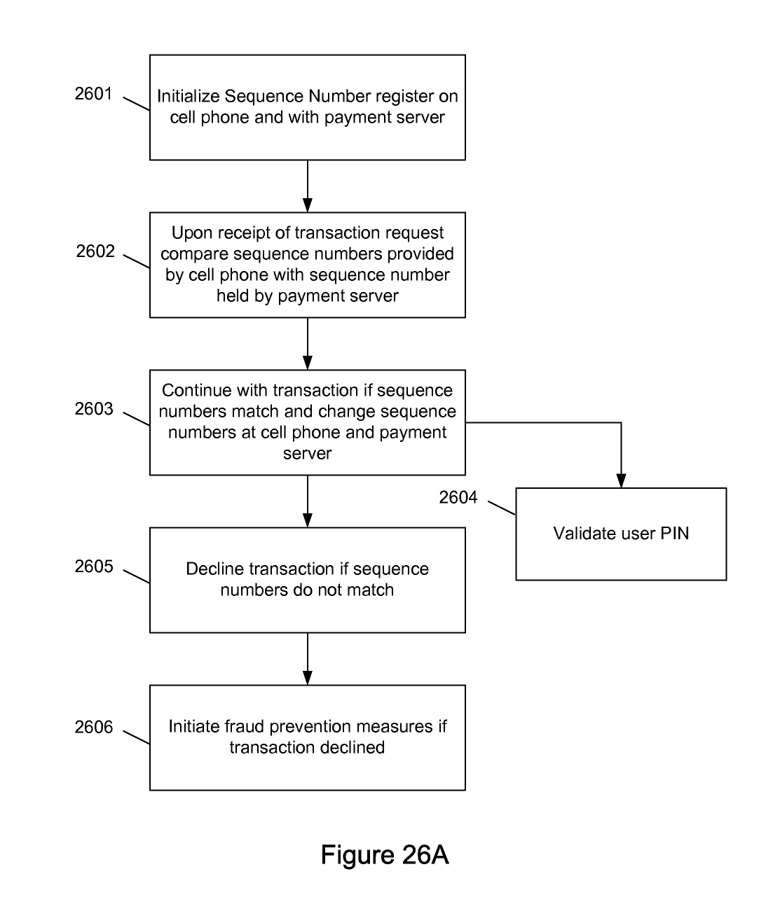

FIGS. 26A and 26B show a mechanism and method for preventing fraud and multiple duplicate transaction requests in accordance with an embodiment of the present invention. The fraud prevention mechanism includes the storage of a sequence number in a register on each cell phone and at the payment server. Typically, as indicated at 2601, the sequence number is initialized when the cell phone payment service is activated. This sequence of numbers can be generated at the client device using a seed created from, for example, a hash function on information such as the telephone number, time of day, or other. At the time of initialization, the payment server is provided the initial sequence number from the client and knows the algorithm and seed, so it can predict what sequence number should be next. The particular method for generating the sequence number can be any suitable technique, including sequential, algorithmic, cryptographic and so on. The sequence numbers can, but need not be, sequential, as long as the seed provided by the client device is known to the server, and the technique by which the next sequence number is generated is also known to the server. In an embodiment, for example, the sequence numbers can be generated based on the time of day or other form of timestamp, where both client and server use the same timebase. In such an arrangement, the sequence numbers increment simply based on the different time stamp, without requiring a specific increment from one sequence number to the next.

In the example illustrated in FIG. 26B, the consumer device 2610 includes an SNA client software component 2615 and generates a number “12” which is stored on the device and communicated to the server 2620, where an SNA server software component 2625 keeps track of the sequence numbers generated by the client and provided to the server.

Upon receipt of a transaction request, as indicated at 2602, the payment server receives a sequence number from the cell phone and compares it with the sequence number held or generated by the payment server. If the sequence numbers match, as indicated at 2603, then the payment server authorizes the transaction to continue. The sequence numbers at both the cell phone and payment server are then updated to a new sequence number according to a predefined technique. This security mechanism is used to prevent spoofing attacks or cloned phones. The user is then requested to enter their PIN as indicated at 2605. By coupling the use of the sequence number with the PIN and the cell phone number, there is a three-level security blanket that authenticates the user (PIN), the phone number (detected by caller ID and linked to a specific account) and the sequence number to validate the transaction (prevents an intruder from attempting to capture a transaction and then resubmit duplicate requests for a transaction). The sequence number is also used to discriminate multiple attempts of the SMS system to deliver a transaction message from valid multiple transactions, thus providing idempotence.

If the sequence numbers do not match, the payment server declines the transaction request, as indicated at 2606, and fraud prevention measures are activated, as indicated at 2607. By way of examples, when the sequence numbers do not match, the account can be frozen until a customer service representative can determine the cause of the mismatched sequence numbers. This can necessitate a phone call the account holder to see if they are still in possession of their phone and whether they had authorized the attempted transaction.

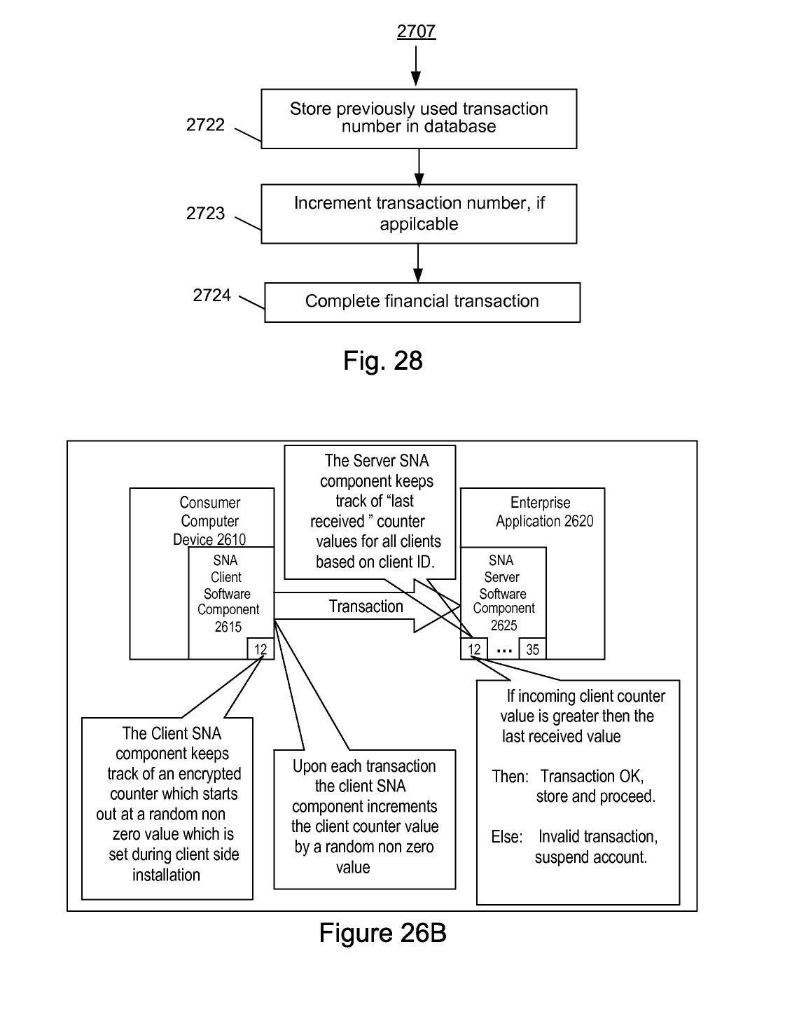

FIGS. 27, 28 and 29 show another embodiment of the mechanism and method for preventing fraud and multiple duplicate transaction requests in accordance with an embodiment of the present invention wherein multiple forms of authentication are checked before permitting a transaction.

At 2710 a user (i.e., an account holder) initiates a financial transaction on a mobile telephony device (e.g., a mobile phone). At 2711, the user transmits a PIN at the time the transaction is initiated (Option A). Alternatively, as indicated at 2712, the user does not transmit a PIN at time the transaction is initiated (Option B).

At 2713, the payment server receives the request from the mobile device to start the financial transaction. The server then checks the caller identification (caller ID) number transmitted by mobile device to see whether mobile device is an authorized user of the system, as shown at 2714. If caller ID is not enabled on the phone, the transaction is disallowed as indicated at 2715. An error message can be shown to indicate the transaction was disallowed because caller ID not enabled. The user can retry the request after enabling caller ID.

If option B was selected, the server must then send a request to the mobile device requesting the user to transmit a PIN, as indicated at 2716. This PIN can be transmitted via a keypad of the mobile device or voice [e.g., to an interactive voice response (IVR) unit of the server].

Once the Caller ID is validated, the server then checks the PIN transmitted from mobile device against PIN recorded in system to verify that the PIN matches the expected phone number as indicated, at 2717. If and only if the PIN matches will the server allow the transaction to proceed. If the PIN does not match, then the transaction is disallowed, as indicated at 2718.

The server then receives a transaction number for the financial transaction from the mobile device. The transaction number can be sent at the time the transaction is initiated or later as part of the information transfer between the mobile device and the server. In an embodiment, the transaction number includes idemopotence keys that make it unique. In other embodiments, the transaction number is similar to the sequence number described previously.

As indicated at 2719, the server also checks the present transaction number from the mobile device against a listing of transaction numbers already previously used, which can be maintained in the form of a sequence number log and can be maintained in accordance with a set of rules. This listing and the rules are stored in a database associated with the server. If the present sequence number is disallowed by a server verification routine, the user is not authenticated and the transaction will be disallowed, as indicated at 2720. This verification step is useful in preventing multiple copies of a message from being treated as a new and independent message. It also prevents replay attacks where a hacker has intercepted a message and is attempting to resubmit an old transaction.

In some embodiments, the server also checks the transaction or sequence number as received from the mobile device against an expected transaction or sequence number stored at the server as indicated at 2721. If the sequence numbers do not match, the user is not authenticated and the transaction will be disallowed as indicated at 2720.

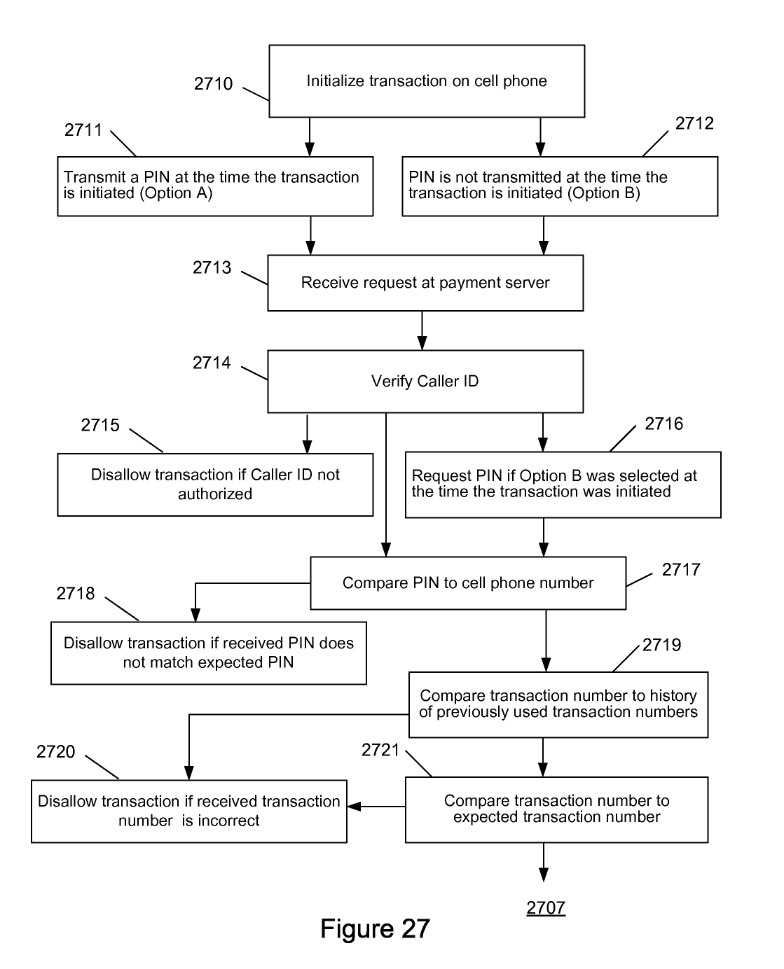

If the sequence number from the phone matches the sequence number stored or expected on the server or is a number not rejected by analysis of the sequence number logs, the user is authenticated and the financial transaction will be allowed to proceed. In some embodiments, the server only performs the transaction number verification as indicated at 2719. In other embodiments, the server only performs the transaction number verification as indicated at 2721. In other embodiments, the server only performs the transaction number verification as indicated at 2719 and at 2721. As long as the server determines that the sequence number from the phone is appropriate or is the expected sequence number, or both, the transaction will be allowed. The sequence number can also be used as a reasonably unique transaction identifier. Step 2721 connects to a step 2722 in FIG. 28 via a link 2707.

The server also stores the sequence number for the current transaction as a sequence number that has been used, as indicated at 2722. These previously used sequence numbers can be stored in a database on the server. If the server maintains an expected sequence number, the sequence number at the phone and server are incremented in preparation for the next transaction as indicated at 2723. The server then proceeds with completing the financial transaction, as indicated at 2724.

In certain embodiments of the invention, a three-factor authentication technique may be used to secure the transactions based on the following authentication according to multiple factors:

(1) Check caller ID

(2) Check PIN or personal identification number

(3) Check transaction number

The above validation method presents some authentication steps in a specific order. An implementation of the invention performs the steps in the given order. However, in other implementations of the invention, other steps can be included or some steps can be omitted, or the order of the steps can be different from above. For example, the caller ID, PIN, and transaction can order independent. Therefore, in an embodiment, the PIN can be checked before the caller ID. In another embodiment, the transaction number can be checked before the PIN. Furthermore, some steps above can be performed at the same time on different processors or processor cores in a parallel processing implementation.

In an implementation, a system of the invention can omit one or more of the authentication techniques listed above. For example, the caller ID cannot be authenticated, so then a two-factor authentication approach will be used.

A traditional model for two-factor authentication is based on (1) what you have and (2) what you know. A first factor is something a user has such as a mobile phone, personal digital assistant, smartphone, or plastic card. A second factor is something the user knows such as a personal identification number (PIN), mother's maiden name, street address, social security number, driver's license number, or home phone number.

Whether a three-factor or two-factor authentication is used can depend on the communication channel used by the mobile device and server. For example, when SMS or data services SMS is used, caller ID is available and a three-factor authentication can be used. However, when HTTP or HTTPS is used, caller ID is typically not available and a three-factor authentication will not be used. There can be additional factors used to authenticate an account holder or user, so the technique can have more than three factors. Further, the third factor of authentication can be managed by client side and server side software components.

Exemplary Three-Factor Authentication Flow

(1) Initiate a financial transaction on a mobile telephony device (e.g., mobile phone)

(2a) (Option A) Transmit a PIN at the time step 1 occurs.

(2b) (Option B) Do not transmit a PIN at time step 1 occurs.

(3) At a server, receive the request from the mobile device to start the financial transaction.

(4) At server, check the caller identification (caller ID) transmitted by mobile device to see whether mobile device is an authorized user of the system. If caller ID is not enabled on the phone, disallow the transaction. Show error message indicating transaction was disallowed because caller ID not enabled. User can retry the request after enabling caller ID.

(5) If option A, once caller ID is validated, proceed to step 6. If option B, once caller ID is validated, the server sends a request to the mobile device for the user to transmit a PIN. This PIN can be transmitted via a keypad of the mobile device or voice (e.g., to an interactive voice response (IVR) unit of the server).

(6) Caller ID has validated, so check PIN transmitted from mobile device against PIN recorded in system. If PIN matches, go to step 7.

(7) Receive a transaction number or sequence number for the financial transaction from the mobile device. This transaction number can be sent at the time step 1 occurs, or can be sent later in the information transfer between the mobile device and the server. Proceed to 8a (option C) or 8b (option D) below.

(8a) (Option C) Check the sequence number from the mobile device against a sequence number stored at the server. If the sequence numbers do not match, the user is not authenticated and the transaction will be disallowed.

(8b) (Option D) Check the present sequence number from the mobile device against a listing or database of sequence number already previous used which is stored at the server. If the present sequence number matches any of the previously used sequence numbers, the user is not authenticated and the transaction will be disallowed.

(9) If the sequence number from the phone matches the sequence number stored on the server (for option C) or is a number not previously used (for option D), the user is authenticated and the financial transaction will be allowed to proceed. For option D, in other words, as long as server determines that the sequence number from the phone has not been used before, the transaction will be allowed.

(10a) If option C, the sequence number at the phone and server are incremented in preparation for the next transaction.

(10b) If option D, the sequence number at the phone is incremented to the next sequence number. The previous sequence number is stored or otherwise indicated at the server as a sequence number that has been used. These previously used sequence numbers can be stored in a database on the server.

Various Implementations of Transaction or Sequence Number Authentication

(1) On initialization of service, use an initial transaction number value stored at both the mobile device and server. The initial transaction number can e (1a) or (1b).

(1a) The initial transaction number can be an integer number, such as 0, 1, 2, 3, 4, 5, 6, 7, 8, 9, 10, or other numbers.

(1b) The initial transaction number can be a random number, such as generated by a pseudorandom number generator and a given seed. This seed can be a hash code based on a property or characteristic of the device. For example, the seed can be based on the telephone number, serial number of the device, property or stored value in an integrated circuit of the device, or real time clock value.

(2) When the user uses an application where transaction number authentication is used, the transaction number value will be changed from the initial or previous transaction number value to the next in sequence. The sequence can be any series, mathematical, pseudorandom, or other. The sequence can be finite, infinite, or repeating series. If a repeating series, the number of transaction numbers in the series before it repeats can be based on a number of binary bits used to represent the transaction number.

(2a) For example, the sequence can be arithmetic or geometric. For an example of an arithmetic series, a transaction number can be an incremented by 1 or any other value (or decremented by 1 or any other value) to obtain the next transaction number is sequence. If the transaction number is represented using eight binary bits, the sequence will repeat every 256 numbers. If the transaction number is represented using sixteen binary bits, the sequence will repeat every 65536 numbers. Therefore, the more number of bits that are used the longer the sequence.

(2b) The sequence can be pseudorandom generated by a pseudorandom number generator. The sequence of pseudorandom numbers will be based on the starting seed value. The pseudorandom number can be represented using a floating point number. The floating point number can be stored using a binary floating point representation.

(3) After each transaction, the mobile device and server (where the transaction number of the mobile device will be authenticated against) both generate the next transaction number in sequence according to the same algorithm. If the mobile device uses an arithmetic series, the server will use an arithmetic series. If the mobile device uses a pseudorandom number series, the server will use a pseudorandom number series. The same seed used by the mobile device will be used by the server. Depending on the particular implementation, this seed can be transmitted from the device to the server, or vice versa, or independently determined.

(4) The mobile device and server will each store respective transaction numbers. The transaction number on mobile device can be referred to as a mobile device transaction number. The transaction number on the server can be referred to as the server transaction number.

(5) When a transaction occurs, the server will compare its stored transaction number against the one stored on the mobile device. If the transaction numbers match, an authentication occurs and the transaction will be allowed to proceed. Otherwise, the transaction will be disallowed.

(6) After a transaction is allowed, the transaction numbers will be advanced to the next in sequence at both the mobile device and server.

These techniques of using a transaction number to authenticate the mobile device help prevent fraud, duplicate transactions, and other undesirable circumstances. There are many variations of the specific implementations of transaction number authentication, and any of these variations can be used, and in any combination with the above described approaches. For example, instead of checking whether a transaction number from a mobile device matches a corresponding number at the server, the authentication technique can check whether the transaction number (a) does not match a corresponding number at the server or (b) does not match a previously used number at the server (as previously described in this application).

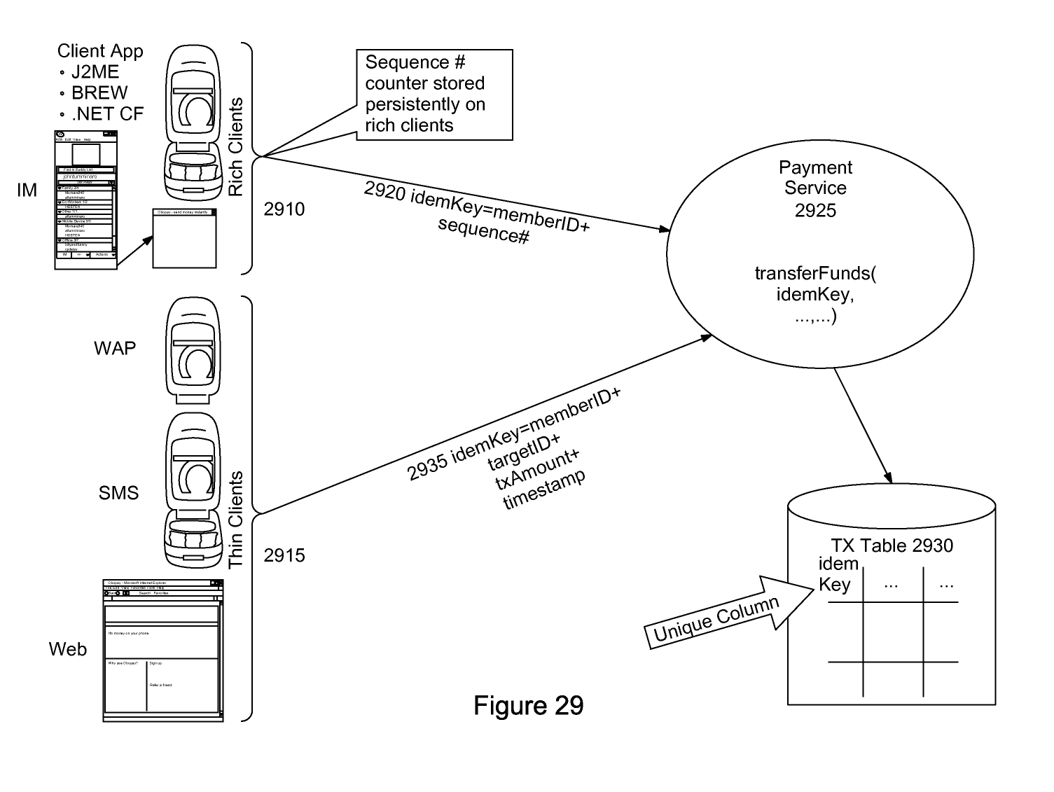

FIG. 29 shows another example of sequence number authentication. In this specific technique, depending on the client from which the transaction is originating, a different type of sequence number is used and sent to the mobile payment service server. For example, a rich client or a thin client can be used.

Examples of a rich client, indicated at 2910, include an application or program running on a mobile phone, smartphone, portable computer, or other electronic device. The application or part of an application can be written in a programming language such as J2ME, BREW, or .NET CF. The application can be a specific application for mobile payments. Or the functionality can be part of another program, such as an instant messenger program, real-time Internet chat program, file transfer program, music player program, video player program, file sharing program, bill paying service interface program, or bill splitting program.

For example, when using an instant messenger program (e.g., AOL Instant Messenger (AIM), ICQ, Yahoo! Messenger, Microsoft Windows Live Messenger, Google Talk, or Skype), there will be an option to send another user a payment. The option to send a payment can be accessible using a right click of a mouse or though a pull-down or cascading menu. The recipient can be identified through user name, member name, phone number, member number, account number, or another identifier. The payment will be processed through the mobile payment service server.

Examples of a thin client, indicated at 2915, include a Web browser application, phone or other device with SMS text messaging, phone or other device with a WAP browser, or terminal emulation program.

In a specific implementation of the invention when using a rich client, a stored sequence number will be stored persistently in a counter in the rich client. This stored sequence number can follow any arbitrary sequence such as sequential integer or binary counter (e.g., 1, 2, 3, 4, and so forth), a random sequence based on a known starting seed value, or sequence according to an equation, formula, or rule. The stored sequence number can be stored, for example, in flash memory, electrically erasable (Ê2) memory, nonvolatile memory, battery-backed memory, hard drive, or other memory.

With each transaction, an idempotence key (called a sequence number or transaction number in other implementations of the invention) is sent to the mobile payment system. For a rich client, the key will include a combination of member ID and the stored sequence number. This stored sequence number can be the next unused stored sequence number. When the mobile payment system receives the rich client's idempotence key, the transaction is stored in a transaction table 2930 along with this idempotence key. In the transaction table, each idempotence key will be expected to be unique. So, if the mobile payment system receives another transaction with a previously received idempotence key, the transaction can be disregarded since it is likely a duplicate transaction or a security problem.

In a specific implementation, the user's account can be flagged with a potential security violation for person to investigate. If a user has a number of such violations or a number of such violations over a particular period of time, then the account can be automatically suspended for pending investigation.

In a specific implementation of the invention when using a thin client, an idempotence key 2935 will include member ID, target ID, transaction amount, and time (or time stamp). The mobile payment system will receive this idempotence key and handle similarly to the situation when receiving a rich client idempotence key.

Therefore, a mobile payment system of the invention can work with different types of clients and each type of client can send different types of idempotence keys or sequence numbers. This embodiment has two different types of idempotence keys, but in other embodiments, there can be any number of idempotence or sequence number key types. For example, there can be three, four, five, six, seven, eight, or more key types.

The sequence number can be stored in a nonvolatile or otherwise persistent memory at the user device, such as flash, electrically erasable (Ê2) memory, magnetic storage, or battery-backed memory. This will ensure each transmission will have a unique value.

The transmitted key can include a pseudorandom number, such as generated using a pseudorandom number generator using a particular seed value. The seed value will change each time a new pseudorandom number is generated, so a sequence of pseudorandom numbers will be generated.

In an implementation, the transmitted key includes a first electronic identifier identifying a user that requested the value exchange transaction, a second electronic identifier identifying a user that is a target of the value exchange transaction, a value amount of the value exchange transaction, and a time associated with the value exchange transaction.

The transmitted key is not displayed on the user device, so it will not be known to the user. This can be useful to prevent people who try to “clone” another user's account and using money in another user's account. In a further implementation, the transmitted key is encrypted to make it for difficult to intercept the wireless transmission of the key.

In an embodiment, processing the value exchange transaction can include generating a transaction identifier number for the value exchange transaction. This transaction identifier number can be generated by the system processing the request, and an electronic message can be sent to the user device including the transaction identifier number. The transaction identifier number can be viewable on the user device. This allows the user to have a reference number for the transaction, so the user can discuss or inquire about the transaction directly with a customer service representation. This transaction identifier can be completely unrelated to the authentication key (which is generated at the user device). The transaction identifier can be generated by a banking partner handling the transaction. In an alternative implementation, the key can be used in generating or creating the transaction identifier.

In an embodiment, the invention is a method including receiving an electronic request for a value exchange transaction, wirelessly transmitted from a user device; receiving a transmitted key associated with the electronic request; generating an expected key; comparing the transmitted key to the expected key; and if the transmitted key matches the expected key, processing the value exchange transaction. The value exchange transaction can be sending money from a first user associated with the user device to a second user associated with another user device, where the user devices a mobile phones.

Generating the expected key can include evaluating a function or equation using a seed value stored for a user account associated with the value exchange transaction. Further, the user account can also store information about the particular function or equation to use to generate the expected key. For example, some users can use one particular function to generate a key while other users use other functions. Different starting seeds are used for different users, and after each use, a new seed will be created for generating of the next key. In other words, the method further includes after evaluating the function, determining a next seed value in sequence and replacing the seed value stored for the user account with the next seed value in sequence.

For example, the user device has a counter that counts in a particular sequence and generates keys in this sequence using a particular function (e.g., pseudorandom number generator). On the server or system side, the server will know the expected key because it is stored in the user's profile and will also know the function to use to generate the key.

There are many existing products, and potentially a large number of new products, that will benefit from the present invention. For example, any Internet-enabled telephone device, such as a voice-over-IP (VOIP) telephone can be used to practice the present invention even though it can be affixed at a specific location and is not necessarily mobile. In other embodiments, e-mail addresses can be used in addition to or in lieu of telephone numbers to identify one or more parties to a financial transaction. Further, the present invention is not limited to cell phones but rather includes any mobile device, handset, PDA, or other communication device having the ability to connect to a communication channel such as the telephone, Internet, cellular, or other wire or wireless communication network.

It will further be appreciated that one or more of the elements depicted in the drawings or figures can also be implemented in a more separated or integrated manner, or even removed or rendered as inoperable in certain cases, as is useful in accordance with a particular application.

Although the invention has been described with respect to specific embodiments thereof, these embodiments are merely illustrative, and not restrictive of the invention. For example, further embodiments can include various display architectures, biometric sensors, pressure sensors, temperature sensors, light sensors, chemical sensors, X-ray and other electromagnetic sensors, amplifiers, gate arrays, other logic circuits, printers, and memory circuits to implement the various embodiments described. The cell phone can be any communication device.

Additionally, any signal arrows in the drawings or figures should be considered as only exemplary, and not limiting, unless otherwise specifically noted. Furthermore, the term “or” as used in this application is generally intended to mean “and/or” unless otherwise indicated. Combinations of components or steps will also be considered as being noted, where terminology is foreseen as rendering the ability to separate or combine is unclear.

As used in the description in this application and throughout the claims that follow, “a,” “an,” and “the” includes plural references unless the context clearly dictates otherwise. Also, as used in this description and throughout the claims that follow, the meaning of “in” includes “in” and “on” unless the context clearly dictates otherwise.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A financial transactions system comprising:
a consumer interface, coupled to a network, comprising:
a Web interface to handle transaction requests from a Web browser client;
a mobile Internet browser to handle transaction requests from a mobile Internet browser on a mobile phone client;
an SMS interface to handle transaction requests using SMS text messaging; and
a mobile client application interface to handle requests from a mobile client application executing on mobile phone client.

2. The system of claim 1 wherein the consumer interface further comprises:
an interactive voice response interface to handle requests from a telephone voice channel.

3. The system of claim 1 comprising:
a pooled account for newly registered users, wherein newly registered users can conduct transactions from registered users immediately after registration.

4. The system of claim 1 wherein the mobile client application interface permits a send money transaction, loading account transaction, unload account transaction, and balance inquiry transaction.

5. The system of claim 1 wherein the consumer interface further comprises:
an instant messenger interface to handle requests from an instant messenger client.

6. The system of claim 1 comprising:
a financial partner interface;
a merchant interface, wherein users through the consumer interface can access their money at a bank coupled to the system through the financial partner interface and transfer money to merchants coupled to the merchant interface.

7. The system of claim 1 comprising:
a system of record managed by the financial transaction system, recording transaction executed through the consumer interface.

8. The system of claim 1 comprising:
a pooled account managed by the financial transaction system, wherein a plurality of the clients accessing the system through the consumer interface have an account in the pooled account.

9. The system of claim 8 wherein a plurality of the clients do not have an account in the pooled account but instead an account at a financial institution, which has access to the system.

10. A method comprising:
providing an application program interface to conduct transactions with a first financial partner;
providing an SMS messenging interface to receive requests to conduct transactions; and
providing a mobile client application interface to receive requests to conduct transactions, wherein through the SMS messenger interface or the mobile client interface, a client can request a transfer money from a first account at the first financial partner to a second account at the second financial partner.

11. The method of claim 10 comprising:
providing an applications program interface to conduct transactions with a second financial partner, wherein through the SMS messenger interface or the mobile client interface, a client can request a transfer money from an account at the first financial partner to an account at the second financial partner.

12. The method of claim 10 comprising:
providing a system of record to record transactions requested through the SMS messenging and mobile client interfaces.

13. A method comprising the steps of
receiving from a sender an electronic request to initiate a remittance transaction for transferring a transaction amount from a sender to a recipient, the request specifying a transaction amount,
electronically sending instructions to a first financial institution to perform a general ledger transfer from an account that belongs to the sender to a first account that is accessible by a payment card system,
directing, via a web service adapted to communicate with a server computer to a plurality of service providers and to a plurality of financial institutions, the first financial institution to participate in a payment transaction in the payment card system, the payment transaction transferring the transaction amount from the first account to one of a group comprising an account that belongs to the recipient maintained at a second financial institution, and a second account that is accessible by the payment card system, and
receiving settlement confirmations from the first and second financial institutions involved in the remittance transaction and the payment card system.

14. A method comprising the steps of
receiving at a server from a sender an electronic instruction to initiate a remittance transaction transferring a transaction amount from a sender to a recipient, the instruction specifying a transaction amount and indicia sufficient to identify the recipient,
responding electronically to the request by performing a general ledger transfer from a direct deposit account that belongs to the sender to a first account that is accessible by a card system; and
participating in a payment transaction in the card system for transferring electronically the transaction amount from the first commercial account to one of a group comprising an account that belongs to the recipient and a second account that is accessible by the card system.

15. The method of claim 14 further comprising the step of submitting to the card system an authorization to perform the remittance transaction.

16. The method of claim 15 further comprising the step of clearing to implement the payment transaction.

17. The method of claim 14 wherein the account that belongs to the recipient is one of a group comprising a debit card account and a credit card account.

18. The method of claim 14 further comprising the step of instructing a recipient financial institution to perform a general ledger transfer from the second commercial account to a direct deposit account that belongs to the recipient.
